(19) United States
(12) Patent Application Publication
(10) Pub. No.: US 2020/0132089 A1
(43) Pub. Date: Apr. 30, 2020

(54) THRUST EXPANSION DEVICE, EXPANSION UNIT, CONNECTING UNIT, AND THRUST EXPANSION SYSTEM

(71) Applicant: Seiko Instruments Inc., Chiba-shi (JP)

(72) Inventor: Shigehiro ARAI, Chiba-shi (JP)

(21) Appl. No.: 16/664,457

(22) Filed: Oct. 25, 2019

(30) Foreign Application Priority Data
Oct. 31, 2018 (JP) 2018-205020
Sep. 26, 2019 (JP) 2019-175376

(51) Int. Cl. F15B 3/00; F15B 11/032

(52) U.S. Cl. CPC F15B 3/00; F15B 2211/21; F15B 11/032

(57) ABSTRACT

In a thrust expansion device, an opposite surface to be opposite to an output surface, on which an output-side lid and a stop lid through which an output rod enters and exits, are disposed, and a plurality of orthogonal surfaces orthogonal to the output surface are capable of being sealed by a sealing lid. A hydraulic chamber transmitting a thrust to a piston portion so as to communicate with an orthogonal surface side and an opposite surface side. In addition, a thrust expansion device includes an output unit having an output surface on which a piston portion and an output rod are disposed, an expansion unit having no output surface, and connecting unit connecting the output unit and the expansion unit.

### RELATED APPLICATIONS

This application claims priority to Japanese Patent Application Nos. 2018-205020, filed on Oct. 31, 2018 and 2019-175376 filed Sep. 26, 2019, the entire content of which is incorporated herein by reference.

### BACKGROUND OF THE INVENTION

### 1. Field of the Invention

The present invention relates to a thrust expansion device, an expansion unit, a connecting unit, and a thrust expansion system, and more particularly to a thrust expansion device that outputs an input pressure as an amplified thrust.

### 2. Description of the Related Art

A fluid pressure cylinder using a fluid such as air (gas) or oil (liquid) is used in many industrial fields.

The fluid pressure cylinder generates a thrust on a piston in a cylinder due to a pressure of a fluid such that the thrust can be a drive force of various types of mechanical actuation such as driving of a press or an actuator.

As such a fluid pressure cylinder, there is an air hydraulic cylinder that converts a pneumatic pressure to a hydraulic pressure inside the cylinder (Japanese Patent No. 4895342).

In the air hydraulic cylinder, the air cylinder (input side) and the hydraulic cylinder (output side) that expands the thrust are combined into a single cylinder, and an air piston that is driven by air is disposed on the input side in the cylinder. The hydraulic piston and an output rod that are driven by using, as an input, the output of the air piston are disposed on the output side.

However, in the air hydraulic cylinder described in Japanese Patent No. 4895342, since an input-side air cylinder unit and an output-side hydraulic cylinder unit (thrust expansion mechanism unit) are integrally formed, the output of the air cylinder unit, a size of the air cylinder, a stroke, and the like are fixed.

Therefore, in a case in which it is necessary to change the stroke of a different air cylinder unit or the like, it is not easy to replace only the air cylinder unit, so that it is necessary to replace the entire air hydraulic cylinder in practice.

### SUMMARY OF THE INVENTION

According to an aspect of the invention, an object thereof is to obtain high expandability with respect to an input actuator, another thrust expansion device, and an expansion unit.

(1) According to a first aspect of the invention, there is provided a thrust expansion device that expands and outputs a thrust input from an input actuator by connecting the input actuator to an input side, the device including a cylinder including an output surface portion having a predetermined output surface, an opposite surface portion disposed to be opposite to the output surface portion, and a plurality of side surface portions disposed on a side of the output surface portion; an output recessed portion constituting a part of a fluid chamber and being formed on the output surface portion; a fluid piston including a piston portion disposed in the output recessed portion and moving in a thrust direction in the cylinder, and an output rod connected to the piston portion and outputting the thrust, an output-side lid portion connected to the output recessed portion and having a through-hole in which the output rod moves in the thrust direction; an input recessed portion constituting a part of the fluid chamber, communicating with the fluid chamber of the output recessed portion, and being formed at at least two locations of the opposite surface portion and the plurality of side surface portions; and an input-side lid disposed at at least one location of an open end of the input recessed portion and having a through-hole formed at a center.

(2) According to a second aspect of the invention, in the thrust expansion device of the first aspect, the device further includes a sealing lid which is disposed on an open end side where the input-side lid is not disposed in the open end and seals an open surface.

(3) According to a third aspect of the invention, in the thrust expansion device of the second aspect, the input recessed portion includes one opposite input recessed portion formed on the opposite surface portion, and a side surface input recessed portion formed at at least one location of the plurality of side surface portions.

(4) According to a fourth aspect of the invention, in the thrust expansion device of the first, the second, or the third aspect, inner circumferential surfaces of the plurality of input recessed portions on an open end side are formed in the same shape at at least two locations.

(5) According to a fifth aspect of the invention, in the thrust expansion device of any one of the first to fourth aspects, the device further includes an adaptor which is disposed at at least one location of the input-side lid and to which the input actuator is connected, or which is disposed at at least one location of the input-side lid or the cylinder, and to which another device such as a robot is connected.

(6) According to a sixth aspect of the invention, in the thrust expansion device of any one of the first to fifth aspects, the input recessed portion of the side surface portion is formed in a direction orthogonal to or inclined with respect to the output surface portion.

(7) According to a seventh aspect of the invention, in the thrust expansion device of any one of the first to sixth aspects, the device further includes fluid supply means for supplying fluid into the fluid chamber partitioned by inner circumferential surfaces of the output recessed portion and the input recessed portion communicating with each other, the piston portion, the input-side lid, and the sealing lid.

(8) According to an eighth aspect of the invention, in the thrust expansion device of any one of the first to seventh aspects, the cylinder includes a plurality of side surface portions orthogonal to the output surface portion, and the plurality of input recessed portions are formed only on the side surface portion.

(9) According to a ninth aspect of the invention, in the thrust expansion device of any one of the first to eighth aspects, a plurality of input recessed portions are formed on at least one same surface portion in the opposite surface portion or the side surface portion.

(10) According to a tenth aspect of the invention, in the thrust expansion device of any one of the first to ninth aspects, the cylinder includes an expansion fluid chamber formed by expanding at least one surface portion of the opposite surface portion and the side surface portion further from the other surface portion, and communicating with the fluid chamber in the cylinder, and the input recessed portion is formed on the expanded surface portion.

(11) According to an eleventh aspect of the invention, in the thrust expansion device of any one of the first to tenth aspects, the input-side lid is disposed at two or more locations.

(12) According to an twelfth aspect of the invention, in the thrust expansion device of the eleventh aspect, the opposite surface portion or/and the side surface portion on which the input-side lid is disposed are formed with a length with which interference does not occur or at a position at which interference does not occur between input rods of the input actuators that enter the cylinder from the input-side lid, and between the input rod and the fluid piston.

(13) According to a thirteenth aspect of the invention, in the thrust expansion device of the twelfth aspect, the input actuator connected to the input-side lid is an air cylinder or an electric cylinder.

(14) According to a fourteenth aspect of the invention, in the thrust expansion device of the thirteenth aspect, the input rod of the input actuator has a circular cross section with no step on an outer circumferential surface.

(15) According to a fifteenth aspect of the invention, in the thrust expansion device of any one of the first to fourteenth aspects, the device further includes output fixing means disposed at at least one location of the cylinder, the output-side lid portion, and the input-side lid for fixing an output attachment that receives an expanded thrust output from the output rod. The output attachment is a replaceable working jig corresponding to a working step or a replaceable assembling jig corresponding to an assembling step.

(16) According to a sixteenth aspect of the invention, there is provided a thrust expansion unit that is connected to the input-side lid disposed at the open end of the thrust expansion device of any one of the first to fifteenth aspects, and transmits a thrust from an input actuator, the thrust expansion unit including an expansion cylinder which includes a bottom surface portion having a bottom portion, an expansion opposite surface portion disposed to be opposite to the bottom surface portion, and a plurality of expansion side surface portions disposed on a side of the bottom surface portion, and in which one location of the expansion opposite surface portion or the expansion side surface portion and the input-side lid are connected; an expansion input recessed portion constituting a part of the fluid chamber, communicating with the fluid chamber of the thrust expansion device, and being formed at at least two locations of the expansion opposite surface portion and the plurality of expansion side surface portions; an expansion input-side lid which is not connected to the input-side lid of the thrust expansion device, is disposed at at least one location of an open end of the expansion input recessed portion, and has a through-hole formed at a center; and an expansion sealing lid which is disposed on an open end side where the expansion input-side lid is not disposed in the open end, and seals an open surface.

(17) According to a seventeenth aspect of the invention, in the thrust expansion unit of the sixteenth aspect, the expansion input recessed portion constituting a part of the fluid chamber is formed on the bottom surface portion.

(18) According to an eighteenth aspect of the invention, in the thrust expansion unit of the sixteenth or the seventeenth aspect, the device further includes an adaptor disposed at at least one location of the expansion input-side lid, and connected to any one of the input actuator, the thrust expansion device, and another expansion unit, or is disposed at at least one location of the expansion input-side lid or the expansion cylinder, and connected to another device such as a robot.

(19) According to a nineteenth aspect of the invention, in the thrust expansion unit of the sixteenth, seventeenth, or eighteenth aspect, inner circumferential surfaces of the plurality of expansion input recessed portions on the open end side are formed in the same shape as the input recessed portion of the thrust expansion device.

(20) According to a twentieth aspect of the invention, there is provided a connecting unit which is connected to two expansion input recessed portions opposite to each other of which inner circumferential surfaces on an open end side are the same so as to connect two thrust expansion devices of the fourth aspect, two expansion units of the nineteenth aspect, or the thrust expansion device of the fourth aspect and the expansion unit of the nineteenth aspect to each other, the connecting unit includes a through-hole through which both of the fluid chambers connected to each other communicate with each other.

(21) According to a twenty-first aspect of the invention, there is provided a thrust expansion system comprising at least one thrust expansion device of any one of the first to fifteenth aspects; at least one expansion unit of the nineteenth aspect; and the connecting unit of the twentieth aspect, which is disposed between two thrust expansion devices, between two expansion units, or between the thrust expansion device and the expansion unit, which are opposite to each other, and connects both respectively.

(22) According to a twenty-second aspect of the invention, in the thrust expansion system of the twenty-first aspect, the system further includes an adaptor which is disposed at at least one location of the input-side lid, and to which the input actuator, the thrust expansion device, another expansion unit, and another device such as a robot are connected.

(23) According to a twenty-third aspect of the invention, there is provided a thrust expansion system including a plurality of the thrust expansion devices of the fifteenth aspect; and the connecting unit of the twentieth aspect, which connects the plurality of thrust expansion devices to each other. The output fixing means for fixing the output attachment that receives an expanded thrust output from the output rod is individually provided in the plurality of thrust expansion devices. Each of the output attachments is a replaceable working jig corresponding to a working step or a replaceable assembling jig corresponding to an assembling step.

According to the present invention, it is possible to obtain high expandability by connecting an input actuator, another thrust expansion device, and an expansion unit to the input-side lid via an adaptor.

### BRIEF DESCRIPTION OF THE DRAWINGS

FIGS. 1A to 1C are sectional views and side views for explaining a thrust expansion device.

FIG. 2 is a view of parts of the thrust expansion device.

FIGS. 3A to 3D are explanatory views of first and second usage examples of the thrust expansion device.

FIGS. 4A and 4B are explanatory views of a third usage example of the thrust expansion device.

FIGS. 5A and 5B are explanatory views of a fourth usage example of the thrust expansion device.

FIGS. 6A and 6B are explanatory views of a fifth usage example of the thrust expansion device.

FIGS. 7A to 7F are explanatory views of a sixth usage example of the thrust expansion device.

FIGS. 8A and 8B are explanatory views of propagation of a pressing force output by the thrust expansion device.

FIGS. 9A to 9E are explanatory views of a second embodiment of the thrust expansion device

FIGS. 10A to 10C are explanatory views of a state in which an air cylinder is attached to the thrust expansion device of the second embodiment.

FIGS. 11A to 11C are explanatory views of another state in which the air cylinder is attached to the thrust expansion device of the second embodiment.

FIGS. 12A and 12B are explanatory views of a state in which an electric cylinder is attached to the thrust expansion device of the second embodiment.

FIGS. 13A to 13C are explanatory views of a third embodiment of the thrust expansion device.

FIGS. 14A to 14C are explanatory views of a fourth embodiment of the thrust expansion device.

FIGS. 15A to 15C are explanatory views of a fifth embodiment of the thrust expansion device.

FIGS. 16A to 16D are explanatory views of a sixth embodiment of the thrust expansion device.

FIG. 17 is another explanatory view of the sixth embodiment of the thrust expansion device.

FIGS. 18A to 18C are explanatory views of seventh and eighth embodiments of the thrust expansion device.

### DETAILED DESCRIPTION OF THE PREFERRED EMBODIMENTS

### (1) Outline of Embodiment

In a thrust expansion device 1 of the present embodiment, a portion constituting a thrust expansion function is separated from a so-called air hydraulic cylinder, which has an input function of inputting a thrust that is a source of the thrust to be output, and a thrust expansion function of expanding and outputting the input thrust as a fluid pressure using a Pascal's principle, and is formed independently.

The thrust expansion device 1 does not operate alone because there is no input in the device itself, and can be operated by assembling various input-side actuators directly or via an adaptor in order to obtain the thrust (input) to be expanded.

Specifically, an input port (through-hole 41) of a fluid chamber (hydraulic chamber 8) that matches rod diameters of various actuators on the input side is provided on the input side of the thrust expansion device 1, a rod (input rod 101 or the like) of the input-side actuator is inserted into the input port, and thereby a thrust expansion mechanism operates.

An input-side actuator attaching portion of the thrust expansion device 1 is configured such that parts can be changed according to a fixing method of various actuators and a rod shape. It is possible to freely change a thrust expansion ratio by changing a cross sectional area of the input rod. A stroke of the output-side rod can be changed by changing an input stroke of the input-side actuator.

According to the thrust expansion device 1, various commonly used cylinders can be easily attached and replaced by being separated and independent from the input-side actuator.

### (2) Details of Embodiment

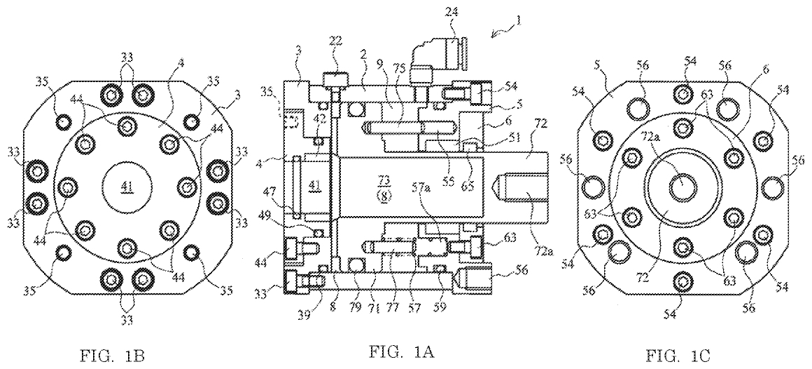

FIGS. 1A to 1C illustrate a configuration of the thrust expansion device 1 according to the present embodiment, in which FIG. 1A illustrates a cross section in a thrust direction (direction of a centerline), FIG. 1B illustrates a side surface from a left side, and FIG. 1C illustrates a side surface from a right side.

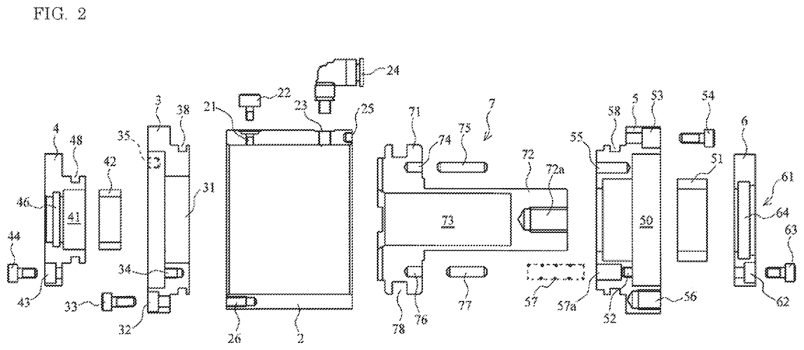

FIG. 2 illustrates each part constituting the thrust expansion device 1. However, an O-ring illustrated in FIGS. 1A to 1C is not illustrated in FIG. 2.

In all the drawings, the thrust output from the thrust expansion device 1 is described in an output direction from the left side to the right side of the drawings. Therefore, the left side of the drawing is referred to as the input side and the right side is referred to as the output side.

As illustrated in FIGS. 1A to 2, the thrust expansion device 1 includes a cylinder 2 that forms a part (circumferential surface) of a hydraulic chamber.

An input-side lid 3 is fixed to an end portion of the cylinder 2 on the input side, and a lid adaptor 4 that can be replaced according to the input-side actuator to be used is attached to a center of the input-side lid 3. The input-side lid 3 and the lid adaptor 4 function as an input-side lid portion.

On the other hand, an output-side lid 5 is fixed to an end portion of the cylinder 2 on the output side, and a stop lid 6 is attached to a center of the output-side lid 5.

A hydraulic piston 7 (fluid piston), which forms a part (one end surface in the thrust direction) of the hydraulic chamber and outputs an expanded thrust, is disposed inside the cylinder 2.

A material of parts (excluding specific parts such as an O-ring and a sliding assistant ring) constituting the thrust expansion device 1 of the present embodiment is a metal such as aluminum, stainless steel, or iron.

As an example, the thrust expansion device 1 has sizes in which an outer diameter is about 70 mm and a stroke length of the output rod 72 is about 5 mm, however, the sizes may be larger or smaller than those described above.

Hereinafter, each of the cylinder 2, the input-side lid 3, the lid adaptor 4, the output-side lid 5, the stop lid 6, and the hydraulic piston 7 will be described.

The cylinder 2 is formed in a cylindrical shape of which both end surfaces are open, a screw hole 25 is formed at the open end on the output side, and a screw hole 26 is formed at the open end on the input side.

The screw hole 25 is a screw hole for fixing the output-side lid 5 by a pressing bolt 54, and female screws are formed inside. Screw holes 25 are formed at six locations on the same circumference corresponding to positions of the pressing bolts 54 illustrated in FIG. 1C.

The screw hole 26 is a screw hole for fixing the input-side lid 3 by a pressing bolt 33, and female screws are formed inside. Screw holes 26 are formed at eight locations on the same circumference corresponding to positions of the pressing bolts 33 illustrated in FIG. 1A.

An oil filler 21 and an inlet/outlet hole 23 penetrate a cylindrical surface of the cylinder 2.

The oil filler 21 is a through-hole for supplying oil into the hydraulic chamber 8 described later, and is closed by an oil filler plug 22. Although one is illustrated in the drawing, two oil fillers 21 and two oil filler plugs 22 are provided on the same circumference of the cylinder 2, and supply oil from either one of them into the hydraulic chamber 8, and the other is used for air bleeding. A hydraulic pressure in the hydraulic chamber 8 may be measured by attaching a pressure sensor to any one of the oil fillers 21.

The inlet/outlet hole 23 is a through-hole for inlet/outlet of air in a pneumatic chamber 9 described later, and is connected to an inletioutlet 24. The pneumatic chamber 9, the inlet/outlet hole 23, and the inlet/outlet 24 function as biasing means that applies a force to the fluid piston in a direction toward the input side.

The input-side lid 3 is formed in a plate shape having a large diameter flange portion and a small diameter portion. The input-side lid 3 has a small diameter portion accommodated in the cylinder 2, and an end surface of the flange portion on the output side, abutting against the open end of the cylinder 2.

Through-holes 32 are formed at eight locations in the flange portion of the input-side lid 3. As illustrated in FIG. 1B, the eight pressing bolts 33 are inserted through the through-holes 32 and screwed into the screw holes 26 of the cylinder 2, so that the input-side lid 3 is fixed to the cylinder 2.

The flange portion of the input-side lid 3 is not circular as illustrated in FIG. 1B, but is formed in a square shape having four corners cut out concentrically. Therefore, four locations of an outer circumferential surface of the flange portion of the input-side lid 3 are formed in a flat shape, and a length between the flat surfaces facing each other is larger than the diameter of the cylinder 2. The shape is the same as that of the flange portion of the output-side lid 5 described later.

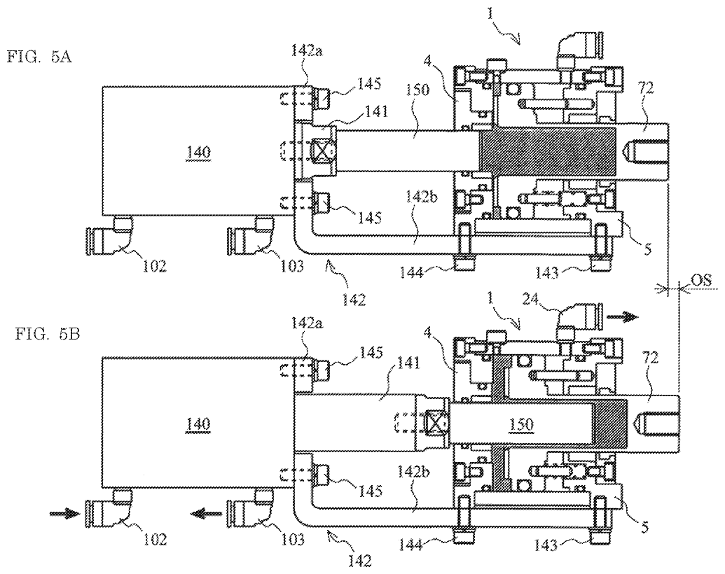

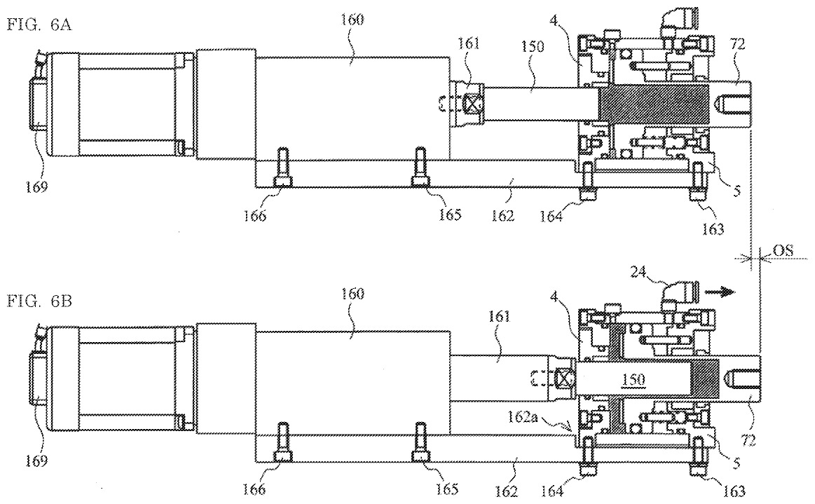

Therefore, the thrust expansion device 1 can be stably mounted on a mounting table or the like by both surfaces positioned on the same surface of the input-side lid 3 and the output-side lid 5. As will be described later, if extension adaptors 142 and 162 are fixed to the side surface of the thrust expansion device 1, the extension adaptors 142 and 162 can be stably bolted to a flat surface of the flange portion by pressing bolts 143, 144, 163, and 164 (See FIGS. 5A to 6B).

Although not illustrated in the drawing, screw holes (not illustrated) for the pressing bolts for fixing the extension adaptors 142 and 162 are formed, in the radial direction, on flat surface portions of an outer circumference of the flange portion in the input-side lid 3 and the output-side lid 5.

At the center of the input-side lid 3, a through-hole 31 (replacing input portion), in which the lid adaptor 4 is disposed, is formed (see FIG. 2). The through-hole 31 of the input-side lid 3 is provided with a stepped portion by forming an inner diameter of the input side larger than that of the output side in accordance with the shape of the lid adaptor 4, and a screw hole 34 is formed in the stepped portion in an output direction.

As illustrated in FIG. 1B, screw holes 35 are formed at four locations on the end surface of the input-side lid 3 on the input side. Since the screw hole 35 does not appear in the cross sections illustrated in FIGS. 1A and 2, the screw hole 35 is illustrated in a dotted line in the drawings. The screw hole 35 is a screw hole for bolting an input cylinder device such as an air cylinder to the thrust expansion device 1.

Further, an outer circumferential groove 38 is formed over the entire circumference on the outer circumferential surface of the small diameter portion accommodated in the cylinder 2 in the input-side lid 3 (see FIG. 2), and an O-ring 39 (see FIG. 1A) is disposed in the outer circumferential groove 38. The O-ring 39 seals oil in the hydraulic chamber 8 described later.

The lid adaptor 4 is disposed in the through-hole 31 of the input-side lid 3, and the lid adaptor 4 is fixed to the input-side lid 3 by a pressing bolt 44.

A through-hole 41 (input portion) is formed at the center of the lid adaptor 4. The through-hole 41 is formed so that an inner diameter on the output side is larger than an inner diameter on the input side.

A guide bush 42 having the same thickness as a difference in inner diameter is disposed on the output side.

An outer diameter of the guide bush 42 is the same as the inner diameter of the through-hole 41 on the output side, and the inner diameter of the guide bush 42 is the same as the inner diameter of the through-hole 41 on the input side. However, the outer diameter of the guide bush 42 is formed to be larger by a press-fit interference (dimensional tolerance range) when the guide bush 42 is press-fitted into the through-hole 41. Further, the inner diameter of the guide bush 42 is larger than the outer diameter of the input rod 101 to be inserted, and the input rod 101 is formed smaller than the inner diameter of the through-hole 41 on the input side within the dimensional tolerance range, so that the input rod 101 does not come into contact with the lid adaptor 4. A length of the guide bush 42 in an axial direction is formed such that the end surface thereof on the output side is shorter than a length to the end surface of the lid adaptor 4 on the output side by the dimensional tolerance.

The guide bush 42 is a guide member that receives input rods of various cylinders attached to the thrust expansion device 1 and guides the movement of the input rod in a front-rear direction (input direction and output direction), on the inner circumferential surface.

In the flange portion of the lid adaptor 4, through-holes 43 are formed at eight locations corresponding to the pressing bolts 44 at eight locations illustrated in FIG. 1B. The pressing bolt 44 is inserted into the through-hole 43 and screwed into the screw hole 34 of the input-side lid 3, whereby the lid adaptor 4 is fixed to the input-side lid 3.

The lid adaptor 4 is appropriately replaced in accordance with the size of the cylinder device disposed on the input side, particularly the size of the input rod inserted into the through-hole 41. The inner diameters of the through-hole 41 and the guide bush 42 of the lid adaptor 4 to be replaced, and a size of an O-ring 47 described later are selected according to the input rod diameter of the cylinder device.

The replacement of the lid adaptor 4 is performed by removing the pressing bolt 44.

According to the present embodiment, by providing the lid adaptor 4 corresponding to the cylinder on the input side separately from the input-side lid 3, the cylinder can be easily replaced to different types of cylinders on the input side while the hydraulic piston 7 is accommodated inside thereof.

The input-side lid 3 and the lid adaptor 4 are not separated, but the input-side lid 3 that is integrally formed is used, is removed by the pressing bolt 33, and may be replaced to an input-side lid 3 matched to the input rod diameter of the cylinder device.

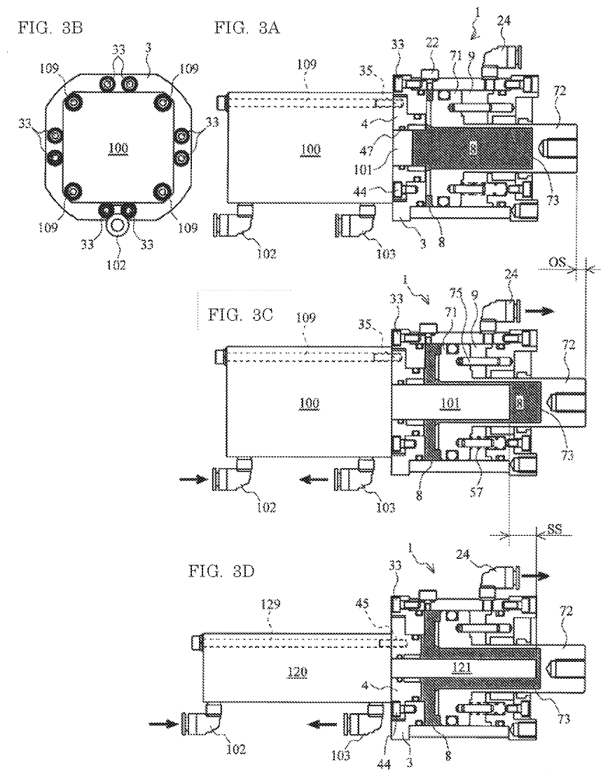

Although not illustrated in FIGS. 1A to 2, according to the lid adaptor 4, for example, as illustrated in FIG. 3D, a plurality screw holes 45 for attaching the cylinder device to the input side of the thrust expansion device 1 are formed.

An inner circumferential groove 46 is formed over the entire circumference of the inner circumferential surface of the through-hole 41 on the input side in the lid adaptor 4 (see FIG. 2), and the O-ring 47 (see FIG. 1A) is disposed in the inner circumferential groove 46.

An outer circumferential groove 48 is formed over the entire circumference of the outer circumferential surface of the small diameter portion in the lid adaptor 4 (see FIG. 2), and the O-ring 49 (see FIG. 1A) is disposed in the outer circumferential groove 48.

Both the O-ring 47 and the O-ring 49 seal oil in the hydraulic chamber described later.

On the other hand, the output-side lid 5 is disposed on the output side of the cylinder 2.

The output-side lid 5 is formed in a plate shape having a small diameter portion and a large diameter flange portion. The small diameter portion of the output-side lid 5 is accommodated in the cylinder 2, and an end surface of the flange portion on the input side abuts against the open end of the cylinder 2.

An outer circumferential groove 58 is formed on the entire circumference of the outer circumferential surface of the small diameter portion in the output-side lid 5 (see FIG. 2), and an O-ring 59 for sealing the air in the pneumatic chamber 9 is disposed in the outer circumferential groove 58 (see FIG. 1A).

Through-holes 53 are formed at six locations in the flange portion of the output-side lid 5. As illustrated in FIG. 1C, the six pressing bolts 54 are inserted into the through-holes 53 and screwed into the screw holes 25 of the cylinder 2, so that the output-side lid 5 is fixed to the cylinder 2.

The flange portion of the output-side lid 5 is formed in a square shape with four corners concentrically cut out as in the case of the input-side lid 3 (see FIGS. 1B and 1C).

As illustrated in FIG. 2, a through-hole 50 in which the stop lid 6 is disposed is formed at the center of the output-side lid 5. A small inner diameter portion, a medium inner diameter portion, and a large inner diameter portion from the input side to the output side are formed on the inner circumferential surface of the through-hole 50 of the output-side lid 5.

In the stepped portion formed by the medium inner diameter portion and the large inner diameter portion, screw holes 52 directed in the input direction are formed at six locations. The screw holes 52 are provided for fixing the stop lid 6 described later to the output-side lid 5.

A guide bush 51 having the same thickness as a difference between the small inner diameter portion and the medium inner diameter portion is disposed in the medium inner diameter portion of the through-hole 50 of the output-side lid 5. A length of the guide bush 51 in the axial direction is the same as the length of the medium inner diameter portion in the axial direction. An outer diameter and an inner diameter of the guide bush 51 are respectively the same as the inner diameter of the medium inner diameter portion and the inner diameter of the small inner diameter portion of the through-hole 50.

However, the outer diameter and inner diameter of the guide bush 51 are formed so as to have a larger outer diameter by a press-fit amount within a range of a dimensional tolerance as in the case of the guide bush 42, and the inner diameter is formed smaller within the range of the dimensional tolerance. Therefore, the inserted output rod 72 does not come in contact with other than the guide bush 51. The length of the guide bush 51 in the axial direction is also shorter than that of the medium inner diameter portion in the range of the dimensional tolerance.

The guide bush 51 is a guide member that receives the output rod 72 of the hydraulic piston 7 disposed in the cylinder 2 on the inner circumferential surface thereof and guides the movement of the input rod in the front-rear direction (input direction and output direction).

On the outside of the medium inner diameter portion of the through-hole 50 of the output-side lid 5, a hole 55 is formed at one location and holes 57a are formed at six locations at positions that do not interfere with each other. The number of holes 55 and holes 57 can be set arbitrarily.

A rotation preventing pin 75 slides inside the hole 55 in the input/output direction in accordance with the movement of the hydraulic piston 7 described later.

An end portion of the coil spring 57 on the output side is inserted and is fixed into and to the hole 57a. The end portion of the coil spring 57 (biasing means) on the input side abuts against the end surface of the piston portion 71 on the output side.

As illustrated in FIG. 1C, the screw holes 56 are formed at six locations on the end surface of the output side lid 5 on output side. The screw hole 56 is provided for attaching various members to the thrust expansion device 1 on output side.

In the through-hole 50 in the output-side lid 5, a stop lid 6 for fixing the guide bush 51 disposed in the medium inner diameter portion is disposed in the large inner diameter portion.

A through-hole 61 into which the output rod 72 is inserted is formed at the center of the stop lid 6. An inner circumferential groove 64 is formed in the through-hole 61 over the entire circumference (see FIG. 2), and a dust seal 65 (see FIG. 1A) is disposed in the inner circumferential groove 64.

The dust seal 65 prevents foreign dust and foreign matters adhering to the output rod 72 from entering the thrust expansion device 1 when the output rod 72 slides. Through-holes 62 are formed at six locations outside the through-hole 61. As illustrated in FIG. 1C, six pressing bolts 63 are inserted into the through-holes 62 and screwed into the screw holes 52 of the output-side lid 5, so that the stop lid 6 is fixed to the output-side lid 5.

The hydraulic piston 7 includes a piston portion 71 and an output rod 72 extending from the center of the piston portion 71 in the output direction. The piston portion 71 is disposed in the cylinder 2, and together with the cylinder 2, an input side surface forms a part of the inner wall of the hydraulic chamber 8, and an output side surface forms a part of the pneumatic chamber 9.

An outer circumferential groove 78 is formed over the entire circumference of the outer circumferential surface of the piston portion 71 (see FIG. 2), and an O-ring 79 (see FIG. 1A) that seals between the hydraulic chamber 8 and the pneumatic chamber 9 is disposed in the outer circumferential groove 78.

A pin hole 74 and a pin hole 76 are formed at locations corresponding to the hole 55 and the hole 57a of the output-side lid 5 on the end surface of the piston portion 71 on the output side.

In the pin hole 74, one end side of the rotation preventing pin 75 is fixed by press-fitting, and the other end side is slidably inserted into the output-side lid 5. The rotation preventing pin 75 restricts the rotation of the piston portion 71 according to the movement in the input/output direction.

One end side of the guide pin 77 is fixed to the pin hole 76 by press-fitting, and the output side is inserted into the coil spring 57 from the press-fitted portion so as to guide the extension and contraction of the coil spring 57. In the present embodiment, six coil springs 57 are disposed circumferentially, but one coil spring may be provided. In this case, the output rod 72 is inserted into the inner diameter of the coil spring, the end portion of the coil spring on the input side may abut against the end surface of the piston portion 71 on the output side, and the end portion of the coil spring on the output side may abut against the end surface of the output-side lid 5 in the input side, with an appropriate positioning groove or the like.

The rotation preventing pin 75 and the coil spring 57 are an example of a rotation stop member.

A bottomed cavity portion 73 that does not penetrate in the axial direction from the input side is formed at the center of the hydraulic piston 7. An inside of the cavity portion 73 also constitutes a part of the hydraulic chamber 8, and the input rod of the cylinder connected to the thrust expansion device 1 enters and leaves the inside of the cavity portion 73.

A bolt hole 72a is formed on the output side of the output rod 72 of the hydraulic piston 7 from the end surface thereof in the input direction. The bolt hole 72a is provided, for example, for attaching various tools such as punches for punching used in a press working or the like.

Next, the use of the thrust expansion device 1 configured as described above will be described.

When the thrust expansion device 1 of the present embodiment is used, various input actuators are attached to the input side to be used.

FIGS. 3A to 3D illustrate first and second usage examples in which the air cylinder that functions as the input actuator is attached to the thrust expansion device 1. In FIGS. 3A to 3D, in order to explain an internal state of the thrust expansion device 1, it illustrates the cross section.

In the first usage example of FIG. 3A, an air cylinder 100 is illustrated in an attached state, FIG. 3B illustrates the left side, and FIG. 3C illustrates an operation state of the thrust expansion device 1 by the air cylinder 100.

As illustrated in FIG. 3A, the air cylinder 100 includes a cylindrical input rod 101 and inlet/outlet holes 102 and 103. The air cylinder 100 is configured such that the front end of the input rod 101 moves in the output direction and the input direction by supplying and exhausting air from the inlet/outlet holes 102 and 103.

In addition, as illustrated in FIG. 3B, the air cylinder 100 is formed such that an external shape of the main body portion is square, and through-holes are formed in the four corners of the main body portion so as to penetrate in the axial direction.

When the air cylinder 100 is attached, four pressing bolts 109 passed through the through-holes of the main body portion are screwed into the screw holes 35 of the input-side lid 3 in a state in which the front end of the input rod 101 is inserted into the through-hole 41 formed in the input-side lid 3 of the thrust expansion device 1, and thereby the air cylinder 100 is fixed to the thrust expansion device 1.

After the air cylinder 100 is attached, the oil filler plug 22 is removed from the cylinder 2 and oil is supplied from the oil filler 21.

In addition, in the thrust expansion device 1 of the embodiment, oil, such as hydraulic fluid which is easily available and is an incompressible fluid, is used as a fluid used for a portion which outputs the fluid as amplified fluid pressure (thrust). However, it is also possible to use a fluid gas, liquid, or gel substance as the fluid to be used. In this case, the hydraulic chamber 8 is filled with the fluid.

In FIGS. 3A to 6B, an oil-filled region is illustrated by a solid color so that a state of the hydraulic chamber 8 filled with oil can be easily understood.

When using the thrust expansion device 1 to which the air cylinder 100 is attached, the inlet/outlet 24 of the thrust expansion device 1 and the inlet/outlet hole 103 of the air cylinder 100 are opened in FIG. 3A, so that the internal air can escape.

In this state, as illustrated in FIG. 3C, air is supplied from the inlet/outlet hole 102 (indicated by a thick arrow), whereby the input rod 101 of the air cylinder 100 moves in the output direction. The internal air escapes from the inlet/outlet 24 and the inlet/outlet hole 103 as indicated by a thick arrow, and enters the hydraulic chamber 8.

Therefore, the oil in a cavity portion 73 of the output rod 72 passes through the outer circumferential side of the input rod 101 and moves between the input-side lid 3, the lid adaptor 4, and the piston portion 71. The piston portion 71 and the output rod 72 move to the output side by a hydraulic stroke OS (see FIGS. 3A and 3C).

From a front end of the output rod 72, a thrust Fp1 amplified (expanded) by the hydraulic pressure is output with respect to the thrust of the air cylinder 100, that is, a thrust Fi from a front end of the input rod 101.

Here, when an area of the front end surface of the input rod 101 is S1, and an area (area including a bottom surface of the cavity portion 73 and the same as the radial sectional area of the cylinder 2) of the piston portion 71 is S2, a force received by the piston portion 71 from the oil in the hydraulic chamber 8, that is, the thrust Fp output from the front end of the output rod 72 is expressed by the following Equation (1):

Fp1=(Fi/S1)×S2=Fi×(S2/S1)

According to the thrust expansion device 1 of the present embodiment, since a relationship of S1<S2 is satisfied, the output rod 72 can output the thrust Fp expanded with respect to the thrust Fi from the input rod 101.

Further, the air cylinder 100 can be easily attached to the thrust expansion device 1.

A case of returning from the state of FIG. 3C in which the expanded thrust is output from the thrust expansion device 1 to the initial state illustrated to FIG. 3A is as follows.

That is, by opening the inlet/outlet hole 102 and supplying air from the inlet/outlet hole 103, the input rod 101 of the air cylinder 100 retreats to the input side.

Therefore, in the hydraulic chamber 8, a space corresponding to a volume in which the input rod 101 was placed is restored, and the space of the through-hole 41 is also restored. In the hydraulic chamber 8, no fluid flows in and out from the outside. Therefore, the oil in the hydraulic chamber 8 flows into the restored space portion, and a negative pressure to the input side is generated in the piston portion 71. Since the atmospheric pressure is applied to the pneumatic chamber 9, the piston portion 71 moves to the input side. In this case, a biasing force of the coil spring 57 assists the movement toward the input side.

Here, in a case of returning to the initial state more reliably, air may be supplied from the inlet/outlet hole 103 and air may be supplied to the pneumatic chamber 9 from the inlet/outlet 24 of the thrust expansion device 1 that has been opened.

The rotation of the piston portion 71 can be suppressed by the rotation preventing pin 75 with respect to the movement in the output direction and the movement in the input direction. Further, since the coil spring 57 extends and contracts along the guide pin 77, it is possible to apply a biasing force to the piston portion 71 in the axial direction.

FIG. 3D illustrates an operation state (corresponding to FIG. 3C) of a second usage example.

The second usage example in FIG. 3D is an example of a case in which a small air cylinder 120 smaller than the air cylinder 100 of the first usage example is attached.

The small air cylinder 120 has a smaller external size of a main body and a smaller diameter of an input rod 121 than those of the air cylinder 100.

Since the external size of the main body is small, a pressing bolt 129 for fixing the small air cylinder 120 to the thrust expansion device 1 is not screwed into the screw hole 35 of the input-side lid 3 but is screwed into the screw hole 45 formed in the lid adaptor 4.

When initially attaching the small air cylinder 120 to the thrust expansion device 1, the through-hole 41 matched with a diameter of the input rod 121 of the small air cylinder 120 and the lid adaptor 4 of the guide bush 42 are used.

On the other hand, as illustrated in FIG. 3A, a case of replacing the air cylinder 100 attached to the thrust expansion device 1 is as follows.

That is, after removing the oil filler plug 22 and draining the oil in the hydraulic chamber 8, the air cylinder 100 is removed, and the pressing bolt 44 is removed to remove the lid adaptor 4 from the input-side lid 3.

Thereafter, the lid adaptor 4 for the small air cylinder 120 is replaced, and is fixed to the input-side lid 3 by the pressing bolt 44. Thereafter, the small air cylinder 120 is screwed into the screw hole 45 by the pressing bolt 129 and is fixed to the thrust expansion device 1. Further, the cylinder 2 is filled with the oil from the oil filler 21 and then the oil filler plug 22 is put.

As described above, in the thrust expansion device 1 of the present embodiment, another cylinder having a different input rod diameter can be easily replaced by replacing the lid adaptor 4.

A stroke of the small air cylinder 120 is longer than that of the input rod 101 of the air cylinder 100 by SS. Therefore, the input rod 121 enters the cavity portion 73 of the output rod 72 as much as the SS, but the length of the cavity portion 73 is sufficiently secured in forward so as to cope with it. Therefore, even if the air cylinder 100 is changed to the small air cylinder 120, it is not necessary to replace the output rod 72.

When an area of the piston portion 71 is the same as S2, an end surface area of the input rod 121 is S3, and the thrust of the small air cylinder 120, that is, the thrust from the front end of the input rod 121 is Fi2, the output Fp2 from the output rod 72 is expressed by the following Equation (2):

Fp2=(Fi2/S3)×S2=Fi2×(S2/S3)

In Equation (2) and Equation (1), when Fi1=Fi2, since S1>S3, it becomes Fp2>Fp1, and a large amplified output can be obtained for the same thrust input.

Next, a third usage example of the thrust expansion device 1 is described.

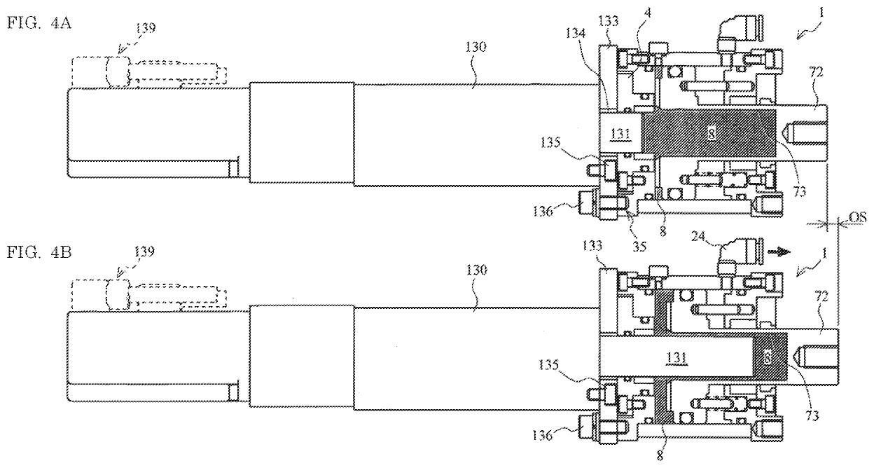

FIGS. 4A and 4B illustrate a usage state for the third usage example.

The third usage example is an example of a case in which an electric cylinder 130 is attached as a cylinder attached to the thrust expansion device 1.

The electric cylinder 130 illustrated in FIG. 4A differs from the air cylinder 100 and the small air cylinder 120 described with reference to FIGS. 3A to 3D, and is an example in a case in which there is no through-hole penetrating the main body, or a case in which the positions of the screw hole 35 and the screw hole 45 do not fit.

In this case, as illustrated in FIG. 4A, the electric cylinder 130 is fixed to the thrust expansion device 1 via an adaptor 133.

Here, in a case in which the electric cylinder 130 can be directly attached to the input-side lid 3 or the lid adaptor 4, the electric cylinder 130 may be directly attached without using the adaptor 133. In FIGS. 3A to 3D, in a case in which the air cylinder cannot be directly attached to the input-side lid 3 or the lid adaptor 4, an adaptor corresponding to the adaptor 133 may be provided to fix to the thrust expansion device 1. The adaptor 133 is provided with a through-hole 134 into which a cylindrical input rod 131 is inserted at the center, a through-hole is formed corresponding to a position of the screw hole 35 of the input-side lid 3, and a through-hole is formed for fixing to the electric cylinder 130.

The input rod 131 passes through the through-hole 134 of the adaptor 133, and the electric cylinder 130 is attached to the adaptor 133 by a pressing bolt 135. Then, the electric cylinder 130 is fixed to the thrust expansion device 1 via the adaptor 133 by screwing a pressing bolt 136 into the screw hole 35 of the lid adaptor 4.

In the sectional view of FIGS. 4A and 4B, since the cross section is changed middle to display the pressing bolt 136, the display position of the screw hole 35 is different from that in FIGS. 1A to 1C, but the actual position of the screw hole 35 is formed at the same position as illustrated in FIG. 1B.

When a cylinder device having a main body of which an external shape is larger than that of the input-side lid 3 is attached, an adaptor having a diameter larger than that of the input-side lid 3 is used. After the adaptor is bolted to the input-side lid 3 (or the lid adaptor 4), the cylinder is fixed by a pressing bolt outside the adaptor from the input-side lid 3.

The electric cylinder 130 is provided with a power feeding unit 139 and controls energization of a built-in motor, so that the input rod 131 can be taken in and out.

By making the inlet/outlet 24 is in an open state and driving the electric cylinder 130 to move the input rod 131 in the output direction. Therefore, as illustrated in FIG. 4B, the input rod 131 enters the inside of the cavity portion 73 (hydraulic chamber 8), and the output rod 72 forwards by the hydraulic stroke OS and outputs the expanded thrust from the front end of the output rod 72.

In this case, the thrust output from the front end of the output rod 72 is obtained according to Equation (1). The principle of thrust expansion is the same as that of the air cylinder.

As described above, according to the thrust expansion device 1 of the present embodiment, the electric cylinder 130 can be easily attached. Therefore, for the input-side actuator, it is possible to optimally select the air drive or electric drive according to the use environment of the device.

In the present embodiment, as the input-side actuator, an air-driven actuator is illustrated in FIGS. 3A to 3D and an electrically driven actuator is illustrated in FIGS. 4A and 4B, but as long as a cylinder-type linear motion actuator having one equivalent to the input rod 131 is used, anything may be used, and as long as the input-side actuator can be attached to the thrust expansion device 1, the thrust of the input actuator can be expanded and output.

When returning from the output state illustrated in FIG. 4B to the initial state illustrated in FIG. 4A, the electric cylinder 130 may be driven to retreat the input rod 131 in the input direction.

Therefore, the piston portion 71 moves to the input side by the negative pressure due to the movement of the oil in the hydraulic chamber 8 to the input side and the biasing force of the coil spring 57.

Here, in a case of returning to the initial state more reliably, air may be supplied to the pneumatic chamber 9 from the inlet/outlet 24 of the thrust expansion device 1 that has been in the opened state.

Next, fourth and fifth usage examples of the thrust expansion device 1 will be described.

Whereas the input rod of each cylinder device described in the first to third usage examples has the cylindrical shape, a cylinder device attached to the thrust expansion device 1 in the fourth and fifth usage examples is an example of a case in which the input rod does not have a single cylindrical shape.

Many of front ends of general cylinder rods have male or female screws at the rod front end, and one or several two-surface width cuts is made on the outer circumferential surface of the input rod to hang a workpiece tool (for example, a spanner) when parts are assembled using the screws. In a case of a non-cylindrical shape such as the two-surface width cut or male screw portion, the oil in the hydraulic chamber 8 cannot be sealed with an O-ring or the like in a range where the portion slides, so that a seal portion cannot be disposed.

Even in a case of a cylindrical shape, there is a case in which the input rod has a stepped shape with a small diameter from a middle of the front end portion, but in the same manner, an O-ring cannot be provided in a range where the stepped portion slides.

It is also possible to insert the irregularly shaped portions deep inside the hydraulic chamber 8 so that they do not slide on the O-ring portion. However, in that case, it is necessary to lengthen the cavity portion 73, which not only increases the size, but also requires replacement of the output rod 72 in some cases. Moreover, when inserting the irregularly shaped portion, the O-ring may be damaged and it cannot assemble easily.

Therefore, in the following usage example, a case will be described in which the actuator having these irregularly shaped portions is configured to be easily coupled to the thrust expansion device 1.

FIGS. 5A and 5B illustrate a state in which an air cylinder 140 having the irregularly shaped portion at the front end portion of the input rod is attached to the thrust expansion device 1, as a fourth usage example.

The air cylinder 140 illustrated in FIG. 5A is provided with a square pole-shaped input rod 141 that is not circular in cross section, for example, in which the two-surface width cut portions are formed at two locations with 90° phase, and an attachment screw hole is formed at the center of the front end.

Since the air cylinder 140 cannot be directly attached to the thrust expansion device 1, the air cylinder 140 is attached by an adaptor rod 150 and an extension adaptor 142.

The adaptor rod 150 has a bolt formed at an end portion on the input side, and is screwed into a screw hole at the front end of the input rod 141. An external shape of the adaptor rod 150 is the same as the inner diameter of the lid adaptor 4 in the thrust expansion device 1.

Since the input rod 141 becomes longer as much as the adaptor rod 150 is attached, in the fourth usage example, the air cylinder 140 is attached to the thrust expansion device 1 by the extension adaptor 142.

The extension adaptor 142 includes a plate-like portion 142a and an extension portion 142b extending from the plate-like portion 142a in a right angle direction.

In the extension portion 142b, through-holes for fixing by the pressing bolts 143 and 144 are formed at positions corresponding to screw holes formed in the output-side lid 5 and the input-side lid 3 of the thrust expansion device 1.

The through-hole for the pressing bolt 143 and the screw hole of the output-side lid 5 are formed at two locations outside avoiding the interference by the pressing bolt 54 illustrated in FIG. 1C. The through-hole for the pressing bolt 144 and the screw hole of the input-side lid 3 are formed at two locations outside avoiding the interference by the pressing bolts 33 and 33 illustrated in FIG. 1B.

On the other hand, the plate-like portion 142a is provided with a through-hole into which the input rod 141 is inserted at a center, and concentric circular through-holes are formed at four locations on the outside thereof.

The adaptor rod 150 has a single cylindrical outer circumferential surface that is a stroke or more of the air cylinder 140, and is designed according to the shape of the input rod 141. For example, if the front end of the input rod 141 is the male screws, the adaptor rod 150 is provided with the female screws.

When attaching the air cylinder 140 to the thrust expansion device 1, the adaptor rod 150 is attached to the input rod 141, and the plate-like portion 142a is attached to the air cylinder 140 by the pressing bolt 145. In this state, the front end of the adaptor rod 150 is inserted into the through-hole of the lid adaptor 4, and the extension portion 142b is fixed to the thrust expansion device 1 by the pressing bolts 143 and 144.

Subsequent filling of the hydraulic chamber 8 with oil is the same as those in other usage examples.

The operation for outputting the expanded thrust from the output rod 72 in the operation state of FIG. 5B and the operation for returning to the initial state by the operation of driving the thrust expansion device 1, to which the air cylinder 140 is attached, are the same as those in the first usage example.

FIGS. 6A and 6B illustrate a state in which an electric cylinder 160 is attached to the thrust expansion device 1, as a fifth usage example.

The electric cylinder 160 illustrated in FIG. 6A includes a power feeding unit 169, and a built-in motor is controlled by power feeding from the power feeding unit 169, so that the input rod 161 can be taken in and out.

The input rod 161 of the electric cylinder 160 is not circular in cross section, and has a square pole-shaped front end in which the two-surface width cut portions are formed at two locations with 900 phase on the outer circumferential surface, and an attachment screw hole is formed at the center of the front end.

Since the electric cylinder 160 cannot also be directly attached to the thrust expansion device 1 like the air cylinder 140, the electric cylinder 160 is attached by the adaptor rod 150 and the extension adaptor 162. The adaptor rod 150 is the same as that used in the fourth usage example.

Since the input rod 161 becomes long as much as the adaptor rod 150 is attached, in the fifth usage example, the electric cylinder 160 is attached to the thrust expansion device 1 by the extension adaptor 162.

The extension adaptor 162 is formed in a plate shape, and as illustrated in FIGS. 6A and 6B, a stepped portion 162a corresponding to a size difference in the radial direction between the thrust expansion device 1 and the electric cylinder 160 is formed. In the example illustrated in FIGS. 6A and 6B, the thrust expansion device 1 is larger, and accordingly, the output side is formed thinner than the input side by the stepped portion 162a.

On the output side from the stepped portion 162a, through-holes for fixing by the pressing bolts 163 and 164 are formed at positions corresponding to the screw holes formed in the output-side lid 5 and the input-side lid 3 of the thrust expansion device 1. The through-holes for the pressing bolts 163 and 164, and the screw holes in the output-side lid 5 and the input-side lid 3 are formed at two locations outside avoiding the interference by the pressing bolts 54 and the pressing bolts 33 illustrated in FIGS. 1C and 1B.

On the other hand, through-holes for the pressing bolts 165 and 166 are formed on the input side from the stepped portion 162a.

When attaching the electric cylinder 160 to the thrust expansion device 1, the adaptor rod 150 is attached to the input rod 161, and the extension adaptor 162 is attached to the electric cylinder 160 by the pressing bolts 165 and 166. In this state, the front end of the adaptor rod 150 is inserted into the through-hole of the lid adaptor 4, and the extension adaptor 162 is fixed to the thrust expansion device 1 by the pressing bolts 163 and 164.

Subsequent filling of the hydraulic chamber 8 with oil is the same as those in other usage examples.

The operation for outputting the expanded thrust from the output rod 72 in the operation state of FIG. 6B and the operation for returning to the initial state by the operation of driving the thrust expansion device 1, to which the electric cylinder 160 is attached, are the same as that in the third usage example.

Next, a sixth usage example will be described.

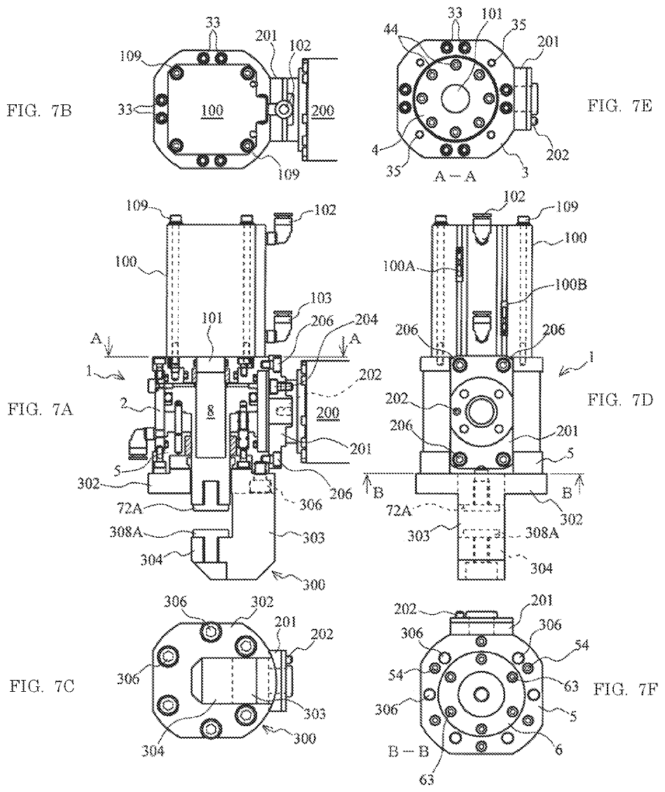

FIGS. 7A to 7F illustrate a state in which an air cylinder 100, an articulated robot arm 200, and an output attachment 300 are attached to the thrust expansion device 1 as the sixth usage example.

FIG. 7A illustrates a state viewed from the front of the thrust expansion device 1, FIG. 7B illustrates a state viewed from above, FIG. 7C illustrates a state viewed from below, FIG. 7D illustrates a state viewed from a side surface, FIG. 7E illustrates a cross section taken along line A-A, and FIG. 7F illustrates a cross section taken along line B-B, respectively.

In addition, FIGS. 7A and 7B illustrate a state in which the articulated robot arm 200 is attached, and the others illustrate a state in which the articulated robot arm 200 is not attached.

Further, in FIG. 7A, as in the first to fifth usage examples described in FIGS. 3A to 6B, the thrust expansion device 1 is illustrated in a cross section for explaining an internal state.

Hereinafter, in each usage example and each embodiment, the articulated robot arm 200 in an articulated robot will be described as an example. It is also possible to attach the thrust expansion device 1 to various robots such as a robot that moves only in a linear direction and a SCARA type robot that moves by rotating an arm.

In the sixth usage example, a state in which the air cylinder 100 is connected is illustrated, but the cylinder connected to the input side is not particularly limited, and any one of the cylinders described in the first to fifth usage examples can be connected.

As illustrated in FIG. 7D, the air cylinder 100 connected to the thrust expansion device 1 of the sixth usage example has two rails disposed on the outer circumferential surface of the cylinder 2 in the axial direction, an input-side sensor 100A disposed on one side, and an output-side sensor 100B disposed on the other side.

The input-side sensor 100A and the output-side sensor 100B are sensors for detecting a position of a magnet (not illustrated) disposed on the piston to which the input rod 101 (see FIGS. 3A to 3D) of the air cylinder 100 is connected. By detecting the position of the piston of the air cylinder 100, it is possible to confirm how much the input rod 101 was inserted into the hydraulic chamber 8 of the thrust expansion device 1 and to confirm a movement distance of the output rod 72. The input-side sensor 100A and the output-side sensor 100B can be disposed in the air cylinders described in the other usage examples.

As illustrated in FIGS. 7A to 7F, when attaching the thrust expansion device 1 to the articulated robot arm 200, a robot adaptor 201 is assembled on the side surface and the thrust expansion device 1 is fixed via the robot adaptor 201.

As illustrated in FIGS. 7A and 7B, the robot adaptor 201 has a rectangular shape, and bolt holes for the pressing bolts 206 are formed at four corners thereof. The robot adaptor 201 is fixed to the input-side lid 3 and the output-side lid 5 by the pressing bolts 206.

For the bolt holes of the input-side lid 3 and the output-side lid 5 for fixing the robot adaptor 201 by the pressing bolts 206, the extension adaptors 142 and 162 described in the fourth usage example and the fifth usage example are fixed by using bolt holes for fixing the pressing bolts 143, 144, 163, and 164. However, bolt holes dedicated to the pressing bolts 206 for fixing the robot adaptor 201 may be formed in the input-side lid 3 and the output-side lid 5.

At the front end of the articulated robot arm 200, a positioning recessed portion for fixing the robot adaptor 201 and fixing bolt holes (four locations) are formed.

A positioning pin 202 for positioning the robot adaptor 201 and the articulated robot arm 200 is press-fitted on a surface of the robot adaptor 201 opposite to a side facing the thrust expansion device 1.

As illustrated in FIG. 7D, the robot adaptor 201 is formed in a rectangular shape, and has bolt holes at four locations for fixing the articulated robot arm 200 by bolts 204 on a concentric circle with the positioning pin 202.

Bolt holes for fixing to the input-side lid 3 and the output-side lid 5 of the thrust expansion device 1 by the pressing bolts 206 are formed at four corners of the robot adaptor 201.

When the thrust expansion device 1 is attached to the articulated robot arm 200, the following procedure is used.

First, the robot adaptor 201 is attached to the front end of the articulated robot arm 200 using the positioning pin 202 and is fixed by the four bolts 204.

Next, the thrust expansion device 1 is fixed to the robot adaptor 201 by the four pressing bolts 206 using the input-side lid 3 and the output-side lid 5.

On the other hand, the output attachment 300 for use in pressing, caulking, or the like is attached to the output side of the thrust expansion device 1.

As illustrated in FIGS. 7A and 7C, the output attachment 300 includes an attachment base portion 302 fixed to the output-side lid 5 of the thrust expansion device 1, an arm portion 303, and an output receiving portion 304 which are formed integrally with the attachment base portion 302.

The attachment base portion 302 is formed in a flat plate shape, and a through-hole into which the output rod 72 of the thrust expansion device 1 is inserted is formed at a center thereof. On the outer circumferential side of the through-hole, through-holes for attaching the attachment base portion 302 to the output-side lid 5 are formed at six locations, and are fixed by the pressing bolts 306.

The pressing bolts 306 for fixing the attachment base portion 302 are fixed by the screw holes 56 (see FIGS. 1A to 2) formed in the bolt hole of the output-side lid 5.

The arm portion 303 has a square pole shape, and extends in a direction orthogonal to the attachment base portion 302 at a position outside the central through-hole in the attachment base portion 302. The output receiving portion 304 is integrally formed on the front end side of the arm portion 303 so as to face the output rod 72 of the thrust expansion device 1 disposed at the center of the attachment base portion 302 in an orthogonal direction.

Similarly to the bolt hole 72a for attaching various tools formed at the front end of the output rod 72, a bolt hole for attaching various tools is also formed at a position facing the output receiving portion 304.

In the output attachment 300 of the example illustrated in FIGS. 7A to 7F, a caulking tool 72A and a caulking tool 308A for caulking are respectively attached to the output rod 72 and the output receiving portion 304.

Next, propagation of the pressing force output from the thrust expansion device 1 in the sixth usage example will be described.

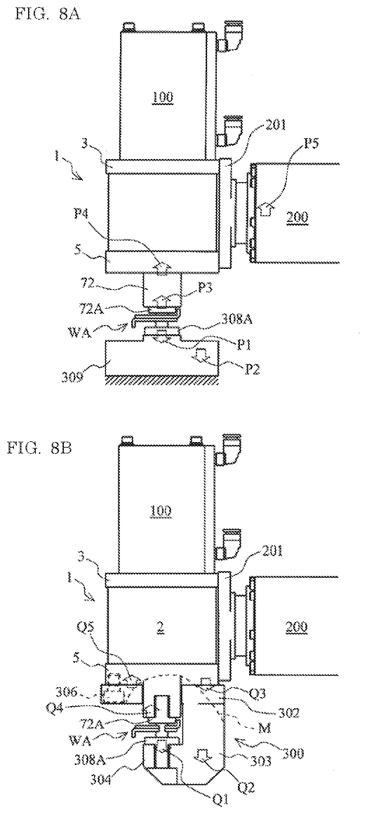

FIGS. 8A and 8B are explanatory views of the propagation of the pressing force output when a caulking process of a workpiece WA is performed by the thrust expansion device 1 attached to the articulated robot arm 200, in which FIG. 8A illustrates a case in which the output attachment 300 is not attached to the output side, and FIG. 8B illustrates a case in which the output attachment 300 is attached to the output-side lid 5. FIG. 8B illustrates the output side from a dotted line M in cross section.

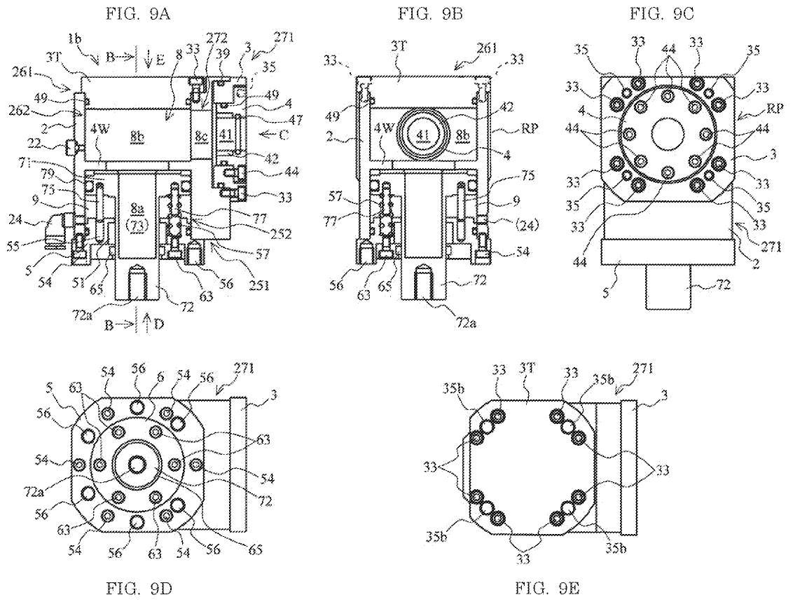

The workpiece WA is the same as a workpiece WA of FIGS. 9A to 91 described later.

As illustrated in FIG. 8A, the workpiece WA is disposed on a caulking tool 308A attached to a cradle 309, and an amplified pressing force P1 is output from the output rod 72 (caulking tool 72A attached to the output rod 72).

An operation of outputting the amplified pressing force P1 (=thrust Fp) from the output rod 72 is as described in FIGS. 3A and 3B.

A load (=pressing force P1) applied to the workpiece WA from the output rod 72 (caulking tool 72A) of the thrust expansion device 1 propagates to the cradle 309 as a pressing force P2, and then propagates to a grounding surface of the cradle 309.

On the other hand, the output rod 72 receives a reaction force P3 equal to the pressing force P1 output to the workpiece WA, from the workpiece WA. The reaction force P3 propagates to a body (cylinder 2, input-side lid 3, and output-side lid 5) of the thrust expansion device 1 as a reaction force P4, and further, a reaction force P5 propagates to the articulated robot arm 200 via the robot adaptor 201.

As described above, in order to perform a process such as pressing, caulking, drilling (punching), or the like without attaching the output attachment 300 to the thrust expansion device 1, it is also propagated to the articulated robot arm 200. For example, when a thrust of 10 kN is output from the thrust expansion device 1, the articulated robot arm 200 is required to have a capacity (loadable weight>propagating reaction force P5+weight of the thrust expansion device 1) sufficient to receive a reaction force of propagating 10 kN.

However, the articulated robot arm 200 having a loadable weight of 10 kN or more is large in size and is not suitable for working a small workpiece from the viewpoint of equipment cost and installation space.

Next, the propagation of the pressing force when the output attachment 300 is attached to the thrust expansion device 1 described in the sixth usage example, and pressing or the like is performed will be described.

As illustrated in FIG. 8B, a load (=pressing force Q1=P1) applied to the workpiece WA from the output rod 72 (caulking tool 72A) of the thrust expansion device 1 propagates from the output receiving portion 304 of the output attachment 300 to the arm portion 303 as a pressing force Q2, and further propagates to the attachment base portion 302 (=Q3).

On the other hand, the output rod 72 receives a reaction force Q4 equal to the pressing force Q1 output to the workpiece WA, from the workpiece WA, and the reaction force Q4 propagates from the body (cylinder 2, input-side lid 3, and output-side lid 5) of the thrust expansion device 1 to the attachment base portion 302 (=Q5).

As illustrated in FIG. 8B, the pressing force Q3 and the reaction force Q5 propagated to the attachment base portion 302 of the output attachment 300 are equal in magnitude and opposite in direction, so that the pressing force Q3 and the reaction force Q5 are canceled each other inside the output attachment 300 (and the thrust expansion device 1).

As described above, even when a large thrust is output from the output rod 72 of the thrust expansion device 1, the pressing force is canceled inside including the output attachment 300 and the reaction force does not propagate to the articulated robot arm 200.

Therefore, unlike the case of FIG. 8A in which the output attachment 300 is not attached, the articulated robot only needs to consider a weight of a unit to be mounted. For example, even in an articulated robot having a loadable weight of about 4 kg (however, weight of the mounting unit including the thrust expansion device 1 is less than 4 kg), it is possible to output a thrust of 10 kN or more from the thrust expansion device 1 and perform working such as pressing, caulking, or drilling.

In the related art, in a case of mainly metal working, a working apparatus is heavy and large because it requires a large working thrust, and is fixed to be used because it cannot be easily moved. Therefore, it has been necessary to move the workpiece to the working apparatus, to process the workpiece, and to return the workpiece to an original position after working.

On the other hand, according to the working apparatus using the thrust expansion device 1 described in the sixth usage example, since the thrust expansion device 1 is small and light in weight with respect to the output, the thrust expansion device 1 is fixed to the articulated robot arm 200 and moved by the articulated robot, so that it is possible to perform various processes such as caulking and drilling. A small articulated robot with a small loadable weight can also be used. Therefore, without moving the workpieces installed on a line, the working apparatus using the output attachment 300 and the thrust expansion device 1 is moved to a workpiece installation location by the articulated robot arm 200, and working such as drilling, or caulking can be performed.

As described above, according to the sixth usage example, without moving the workpiece from a production line, it is possible to process the workpiece on the line by moving the working apparatus using the output attachment 300 and the thrust expansion device 1, and in particular, if the workpiece is large in size, the work space can be reduced and the effect can be increased.

The case using the output attachment 300 capable of canceling the thrust to be output, in the inside, and performing the caulking process is described. However, the output attachment 300 can be used to perform other processes (drilling, pressing, and the like).

As described with reference to FIGS. 7A to 8B, in the caulking process, the caulking tool 72A and the caulking tool 308A for caulking are respectively attached to the output rod 72 and the output receiving portion 304. On the other hand, although not illustrated, it is possible to perform the drilling process by attaching a drilling tool 72B to the front end of the output rod 72 and attaching a punching tool 308B to the output attachment 300. Similarly, the punching process and the pressing process are performed by attaching a pressing tool 72C to the front end of the output rod 72 and attaching a pressing tool 308C to the output attachment 300.

As for the drilling tool 72B and the punching tool 308B, and the pressing tool 72C and the pressing tool 308C, a shape according to the working content is appropriately selected.

The operation of the thrust expansion device 1 in the drilling process and the pressing process is the same as that in the caulking process.

The output attachment is not limited to the present usage example. For example, a chuck attachment may be attached to hold workpieces of various sizes.

Fixing means for fixing the input actuator (air cylinder 100, electric cylinder 130, or the like), output fixing means for fixing the output attachment (output attachment 300, chuck attachment, or the like), and robot fixing means for fixing the robot adaptor 201 for attaching the articulated robot arm 200 can be disposed at at least one location of the cylinder, the output-side lid portion, and the input-side lid portion. The same applies to a thrust expansion device of a second embodiment described below.

Next, the thrust expansion device according to the second embodiment will be described.

In the thrust expansion device 1 (hereinafter, referred to as the first embodiment) described with reference to FIGS. 1A to 8B, a case in which one input cylinder (referred to as the air cylinder 100, the small air cylinder 120, the electric cylinder 130, the air cylinder 140, or the like as the input actuator, hereinafter the same) is attached to the output rod 72 on the axis thereof is described.

On the other hand, in the second embodiment, in addition to the axis (output axis) of the output rod 72, the input cylinder can be attached to the output rod 72 on an orthogonal axis that is orthogonal (or inclined) to the axis.

That is, in the second embodiment, when a surface, on which an output-side lid 5 and a stop lid 6 through which the output rod 72 enters and exits are formed, is used as the output surface, surfaces of two locations of a surface (hereinafter referred to as an opposite surface) to be opposite to the output surface and a surface (hereinafter referred to as an orthogonal surface) to be orthogonal to the output surface enable the attachment and removal of the input-side lid 3 described in the first embodiment, and a hydraulic chamber 8 transmitting the thrust to a piston portion 71 is expanded so as to communicate with an orthogonal surface side and an opposite surface side.

The air cylinder 100 or the like is attached to either one of the opposite surface and the orthogonal surface via the input-side lid 3 and the lid adaptor 4, and a sealing lid 3T for sealing the hydraulic chamber 8 is attached to the other side.

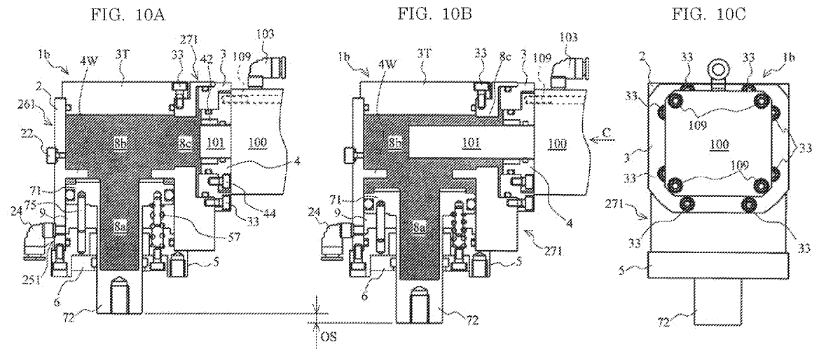

FIGS. 9A to 9E are explanatory views illustrating a cross section of a thrust expansion device 1b according to the second embodiment. In the thrust expansion device 1b illustrated in FIGS. 10A to 10C, a case is described in which the air cylinder 100 is connected to the input side, as in the first usage example (FIGS. 3A to 3C) in the first embodiment.

FIGS. 9B to 9E respectively illustrate a cross section taken along line B-B, a view of the thrust expansion device 1b viewed in a direction of arrow C, a view of the thrust expansion device 1b viewed in a direction of arrow D, and a view of the thrust expansion device 1b viewed in a direction of arrow E respectively illustrated in FIG. 9A. The same portions as those of the thrust expansion device 1 in the first embodiment are denoted by the same reference numerals, and the description thereof is omitted as appropriate. The description will focus on the different portions.

As illustrated in FIGS. 9A to 9E, the cylinder 2 of the thrust expansion device 1b is formed in a rectangular parallelepiped shape including an output surface portion 251 having an output surface, an opposite surface portion 261 having an opposite surface, and an orthogonal surface portion 271 (side surface portion) having an orthogonal surface.

In the cylinder 2, an output recessed portion 252 having an output surface as an open surface is formed inside the output surface portion 251, and an opposite input recessed portion 262, which communicates with the output recessed portion 252 and has an opposite surface as an open surface, is formed on the opposite surface portion 261. An orthogonal input recessed portion 272 (side surface input recessed portion), which communicates with the opposite input recessed portion 262 and has an orthogonal surface as an open surface, is formed in the orthogonal surface portion 271.

The output recessed portion 252, the opposite input recessed portion 262, and the orthogonal input recessed portion 272 are all formed in a cylindrical shape. The axis of the output recessed portion 252 and the axis of the opposite input recessed portion 262 coincide with each other, and the axis of the output recessed portion 252 and the axis of the orthogonal input recessed portion 272 intersect with each other in the orthogonal direction.

As in the first embodiment, a piston portion 71 to which the output rod 72 is connected, a rotation preventing pin 75, a coil spring 57, and the like are disposed in the output recessed portion 252, and the output-side lid 5 and the stop lid 6 are disposed on the output surface that is the open surface.

The opposite input recessed portion 262 is formed coaxially with the output recessed portion 252, and the sealing lid 3T is disposed on the opposite surface that is the open surface. The sealing lid 3T is fixed to the cylinder 2 by pressing bolts 33.

The output recessed portion 252 and the opposite input recessed portion 262 are partitioned by an abutting wall 4W, and are in communication with each other through a through-hole formed at a center of the abutting wall 4W. The abutting wall 4W has a function of defining a position in an initial state when the piston portion 71 abuts against the abutting wall 4W, similarly to the input-side lid 3 in the first embodiment.

The orthogonal input recessed portion 272 is formed such that the orthogonal surface, which is the open surface, has the same inner diameter as that of the opposite input recessed portion 262, and a side communicating with the opposite input recessed portion 262 is formed in a smaller diameter than that of the orthogonal surface side.

As in the first embodiment, the input-side lid 3 and the lid adaptor 4 are disposed in the orthogonal input recessed portion 272 so that the air cylinder 100, the electric cylinder 130, or the like can be connected thereto.

The sealing lid 3T of the opposite input recessed portion 262 and the input-side lid 3 (and the lid adaptor 4) of the orthogonal input recessed portion 272 are formed with bolt holes for the pressing bolts 33 at the same positions so that both can be replaced.

That is, various input cylinders such as the air cylinder 100 can be attached to either the opposite input recessed portion 262 or the orthogonal input recessed portion 272 by the input-side lid 3 and the lid adaptor 4. In this case, the sealing lid 3T is attached to a side where the input cylinder is not attached.

The input cylinder is not basically attached to the sealing lid 3T, but screw holes 35b are formed at the same positions as the screw holes 35 for the air cylinder 100 provided in the sealing lid 3T. The diameter of the screw hole 35b is different from that of the screw hole 35, but may have the same diameter.

Inside the thrust expansion device 1b, hydraulic chambers 8a, 8b, and 8c communicating with each other are respectively formed in each inside of the output recessed portion 252, the opposite input recessed portion 262, and the orthogonal input recessed portion 272.

That is, as illustrated in FIG. 9A, the hydraulic chamber 8a is formed by an inner circumferential surface of the output recessed portion 252, the abutting wall 4W, an end surface of the piston portion 71, the piston portion 71, and a cavity portion 73 of the output rod 72. The hydraulic chamber 8a corresponds to the hydraulic chamber 8 in the first embodiment.

The hydraulic chamber 8b is formed by the inner circumferential surface of the opposite input recessed portion 262, an inner end surface of the sealing lid 3T, and the abutting wall 4W. The hydraulic chamber 8c is formed by the inner circumferential surface of the orthogonal input recessed portion 272, the input-side lid 3, and an end surface of the lid adaptor 4.

In each of the following embodiments, each of the hydraulic chambers 8a, 8b, and 8c communicating with each other is referred to as a hydraulic chamber 8 when referring to the entire hydraulic chamber, and when indicating an individual hydraulic chamber, description will be made with the subscripts such as a, b, and c in the hydraulic chamber 8.

Unlike the first embodiment, in the thrust expansion device 1b of the second embodiment, an oil filler (through-hole) for supplying oil from the outside to the hydraulic chambers 8a to 8c is formed in the opposite input recessed portion 262 of the cylinder 2, and is sealed by a filler plug 22.

The oil filler and the oil filler plug 22 function as fluid supply means for supplying the fluid into the hydraulic chamber 8 described later.

For the thrust expansion device in each of the second and subsequent embodiments, although an internal shape of the cylinder 2 is formed in a cylindrical shape with respect to each axis (output axis, orthogonal axis, or the like), an external shape does not necessarily have a rectangular parallelepiped shape. For example, it is not necessary to be a flat surface except for locations where an output surface, an opposite surface parallel to the output surface, and an orthogonal surface orthogonal to the output surface are formed, and it can be formed as a curved surface.

As described above, although description is omitted in the structure of the thrust expansion device 1b in the second embodiment, the robot adaptor 201 and the output attachment 300 (see FIGS. 7A to 8B) can be also attached as described in the first embodiment.

In this case, the robot adaptor 201 can be attached to a surface other than the output surface portion 251, the opposite surface portion 261, and the orthogonal surface portion 271 of the cylinder 2. However, the robot adaptor 201 can be also attached to the sealing lid 3T which is attached to the opposite surface portion 261 or the orthogonal surface portion 271.

Further, the output attachment 300 is attached to the output-side lid 5 of the output surface portion 251.

However, by changing a shape of an attachment portion of the output attachment 300, the output attachment 300 can be attached to the attachment surface of the cylinder 2 and the sealing lid 3T in the same manner as the robot adaptor 201.

The attachment of the robot adaptor 201 and the output attachment 300 is the same in each of the third and subsequent embodiments.

FIGS. 10A to 10C are operation explanatory views when the sealing lid 3T is attached to the opposite surface portion 261 and the air cylinder 100 is attached to the orthogonal surface portion 271 as a usage example of the thrust expansion device 1b. FIG. 10A illustrates an initial state of the thrust expansion device 1b, FIG. 10B illustrates a driving state, and FIG. 10C illustrates a state when the thrust expansion device 1b is viewed in a direction of arrow C in FIG. 10B.

In FIGS. 10A to 10C, in order to explain a state of the thrust expansion device 1b, it represents in the cross section. The air cylinder 100 to be attached is the same as the air cylinder 100 described in the first usage example of FIGS. 3A to 3D.

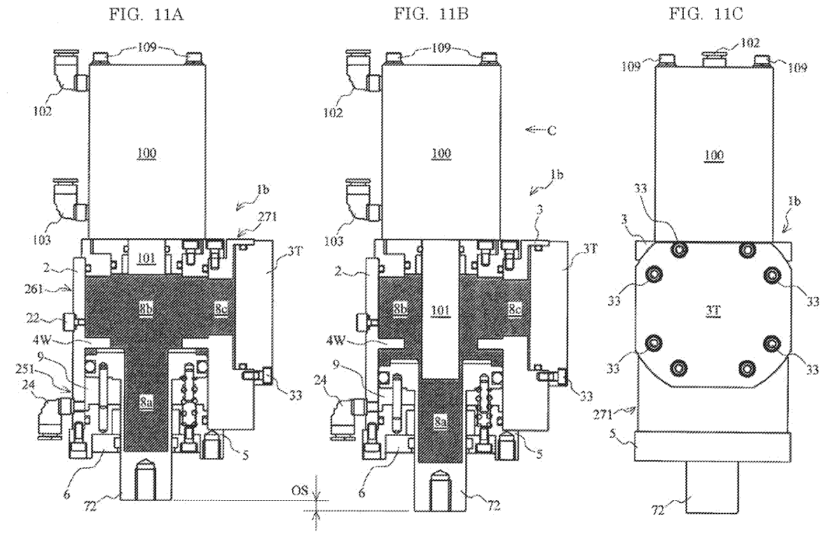

In FIGS. 10A to 10C, similarly to FIGS. 3A to 3D, an oil-filled region is illustrated by a solid color so that a state of the hydraulic chambers 8a to 8c filled with oil can be easily understood (same applies to FIGS. 11A to 11C and thereafter).

As illustrated in FIGS. 10A to 10C, compared with the first usage example (see FIGS. 3A to 3D) of the first embodiment in which the attaching direction of the air cylinder 100 is the axial direction of the output rod 72, the thrust expansion device 1b of the present embodiment is different in that the air cylinder 100 is attached to the orthogonal surface portion 271 that faces in a direction orthogonal to the axis of the output rod 72.

In the first embodiment, the end surface of the piston portion 71 forms the hydraulic chamber 8, and the input rod 101 similarly enters the hydraulic chamber 8, thereby applying the input thrust of the air cylinder 100 to the hydraulic chamber 8.

On the other hand, in the thrust expansion device 1b of the second embodiment, similarly, the end surface of the piston portion 71 forms the hydraulic chamber 8a, and the input rod 101 enters the hydraulic chambers 8b and 8c communicating with the hydraulic chamber 8a. Therefore, the input thrust of the air cylinder 100 is applied to the hydraulic chambers 8a to 8c.

Therefore, the operation when driving the thrust expansion device 1b illustrated in FIGS. 10A to 10C is the same as that in the first usage example (FIGS. 3A to 3C) of the first embodiment in which the same air cylinder 100 is connected to the input side.

When air is supplied from the inletoutlet hole 102 (see FIGS. 3A to 3D) in a state in which the inlet outlet hole 103 of the air cylinder 100 is open, as illustrated in FIG. 10B, the input rod 101 enters the hydraulic chamber 8c.

When the input rod 101 enters the hydraulic chamber 8c and pushes the oil in the entire hydraulic chambers (8a to 8c), the piston portion 71 and the output rod 72 move in the output direction (downward in the drawing) by a hydraulic stroke OS (about 5 mm similar to the first embodiment). The thrust amplified by the hydraulic pressure is output from the front end of the output rod 72.

A case, in which the thrust expansion device 1b is returned from the state in which the expanded thrust is output to the initial state, is the same as that of the first usage example of the first embodiment.

FIGS. 11A to 11C are operation explanatory views when the sealing lid 3T is attached to the orthogonal surface portion 271 and the air cylinder 100 is attached to the opposite surface portion 261 as another usage example of the thrust expansion device 1b. FIG. 11A illustrates an initial state of the thrust expansion device 1b, FIG. 11B illustrates a driving state, and FIG. 11C illustrates a state when the thrust expansion device 1b is viewed from a direction of arrow C in FIG. 1 lB.

The present usage example is the same as the first usage example of the first embodiment, and the operation thereof is the same as the operation described with respect to FIGS. 3A to 3D, except that the air cylinder 100 is attached at a position spaced apart from the output-side lid 5 by a length of the hydraulic chamber 8b and a thickness of the abutting wall 4W.

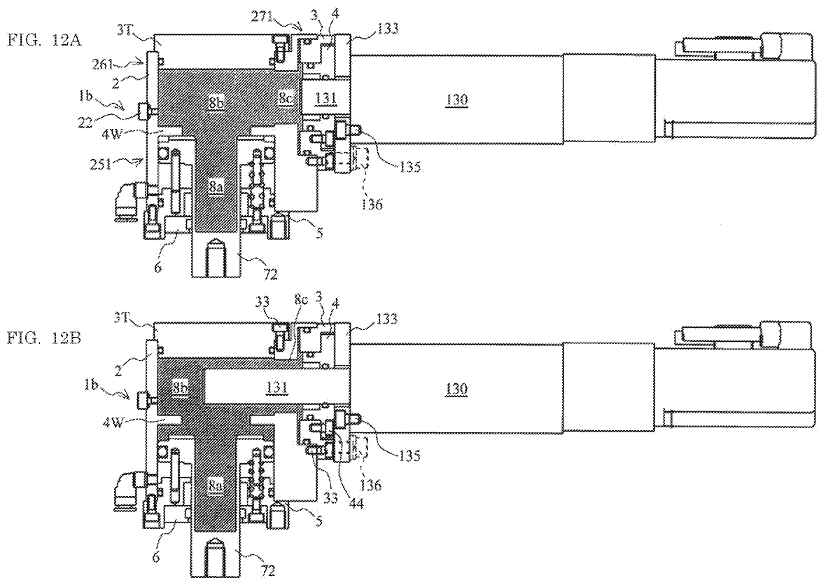

FIGS. 12A and 12B are operation explanatory views in a case in which the sealing lid 3T is attached to the opposite surface portion 261 and the electric cylinder 130 is attached to the orthogonal surface portion 271 as still another usage example of the thrust expansion device 1b. FIG. 12A illustrates an initial state of the thrust expansion device 1b and FIG. 12B illustrates a driving state.

In the present usage example, the electric cylinder 130 to be attached is the same as the electric cylinder 130 described with reference to FIGS. 4A and 4B, and the fixing method to the thrust expansion device 1b via the adaptor 133 is also the same as that of the electric cylinder 130.

The operation is the same as that described with reference to FIGS. 4A and 4B except that a direction in which the input rod 131 of the electric cylinder 130 enters the hydraulic chambers 8a and 8b is different from each other.

Although a case in which the electric cylinder 130 is attached to the orthogonal surface portion 271 is described with reference to FIGS. 12A and 12B, the electric cylinder 130 can also be attached to the opposite surface portion 261. In this case, the sealing lid 3T is attached to the orthogonal surface portion 271.

In the same manner as described with reference to FIG. 3D, the small air cylinder 120 can be attached to a side of the output surface portion 251 and the orthogonal surface portion 271, where the input-side lid 3 and the lid adaptor 4 are attached.

The air cylinder 140 described with reference to FIGS. 5A and 5B, and the electric cylinder 160 described with reference to FIGS. 6A and 6B can be similarly connected to the thrust expansion device 1b using the extension adaptors 142 and 162.

About the above point, it is the same also in each of the third and subsequent embodiments.

In the thrust expansion device 1b of the second embodiment described above, a case in which the input cylinder is attached to only one of the opposite surface and the orthogonal surface is described, but it is also possible to attach the input cylinder to both.

That is, the air cylinder 100 can be attached to both the opposite surface and the orthogonal surface.

However, in the thrust expansion device 1b of the second embodiment, there is a positional relationship in which the axis (axis of the input rod when the input cylinder is attached, hereinafter the same) of the orthogonal plane and the axis of the opposite surface intersect each other, and both input rods 101 interfere with each other. Therefore, it is necessary to operate only one of the input cylinders.

Next, third to eighth embodiments will be described.

In the second embodiment described above, a case in which the input cylinder is attached to one of the orthogonal surface and the opposite surface, and the sealing lid 3T is attached to the other surface, or a case (modified example) in which the input cylinders are attached to both the orthogonal surface and the opposite surface, and only one of them is operated is described.

On the other hand, in the third to eighth embodiments, a plurality of input cylinders can be attached by providing a plurality of attachment surfaces (opposite surface, orthogonal surface, inclined surface, and the like) for attaching the input cylinders. In addition, a position of each attachment surface is adjusted so that the respective input rods do not interfere (contact) with each other when a plurality of input cylinders are operated at the same time.

For example, the direction of the input cylinder to be attached can be the same direction (parallel) as the output rod 72 or a right-angle direction (or an inclined direction). A plurality of attachment surfaces are disposed in different directions so that they can be selected according to a situation, and a shape of each attachment surface is made common. The hydraulic chambers 8a to 8c are sealed by attaching the sealing lid 3T to the attachment surface not used for attaching the input cylinder.

A third embodiment will be described.

In a thrust expansion device 1c of the third embodiment, a position of the front end when the input rod of the input cylinder attached to one attachment surface is in front of an operation line of the input rod of the input cylinder attached to the other attachment surface, and thereby the two input rods are provided at positions where the two input rods do not come into contact with each other.

That is, in the third embodiment, a length of the hydraulic chamber 8c in which the input rod of the input cylinder attached to one attachment surface operates is longer than that in the second embodiment.

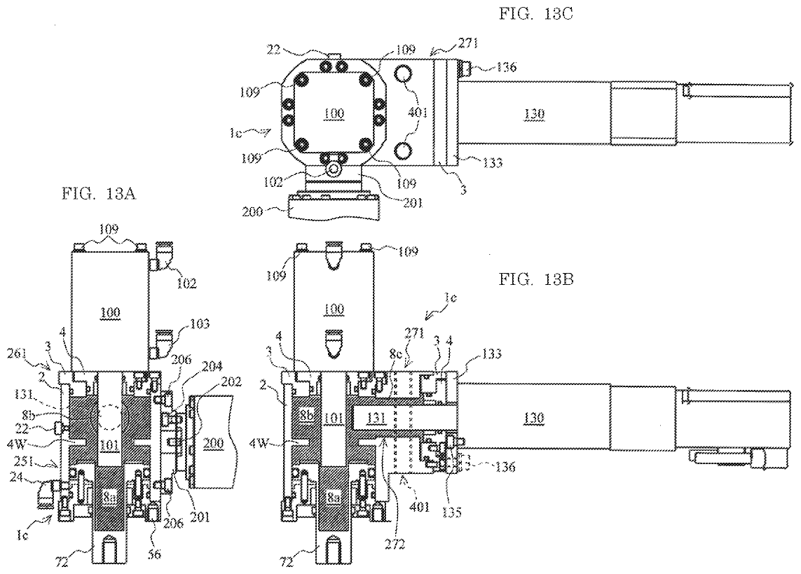

FIGS. 13A to 13C are explanatory views of the third embodiment of the thrust expansion device 1c.

FIGS. 13A to 13C illustrate a state in which the thrust expansion device 1c, to which the air cylinder 100 and the electric cylinder 130 are attached, is attached to an articulated robot arm 200 via a robot adaptor 201. The air cylinder 100, the electric cylinder 130, and the articulated robot arm 200 are the same as those described in the first embodiment.

As illustrated in FIGS. 13A to 13C, similar to the thrust expansion device 1b of the second embodiment, the thrust expansion device 1c includes an output surface portion 251 having an output recessed portion 252, an opposite surface portion 261 having an opposite input recessed portion 262, and an orthogonal surface portion 271 having an orthogonal input recessed portion 272.

The input-side lid 3 and the lid adaptor 4 are attached to the opposite surface portion 261 and the orthogonal surface portion 271, the air cylinder 100 is attached to the opposite surface portion 261 side, and the electric cylinder 130 is attached to the orthogonal surface portion 271 side via the adaptor 133. The attachments of the air cylinder 100 and the electric cylinder 130 are the same as those described in the first embodiment and the second embodiment.

The opposite surface portion 261 and the orthogonal surface portion 271 are disposed at positions where the axes of the input rod 101 and the input rod 131 intersect with each other in a state in which the air cylinder 100 and the electric cylinder 130 are attached.

The axes intersect with each other in the same manner as in the second embodiment, but in the thrust expansion device 1c of the present embodiment, as illustrated in FIG. 13B, in a state in which the air cylinder 100 and the electric cylinder 130 are operated, in order to prevent the front end of the input rod 131 from coming into contact with the circumferential surface of the air cylinder 100, the lengths of the orthogonal surface portion 271 and the orthogonal input recessed portion 272 in the axial direction is longer than those of the second embodiment (longer than the working distance of the input rod 131).

In the present embodiment, the lengths of the orthogonal surface portion 271 and the orthogonal input recessed portion 272 are increased, but conversely, the lengths of the opposite surface portion 261 and the opposite input recessed portion 262 may be increased. In this case, the front end of the input rod 101 of the air cylinder 100 does not come into contact with the circumferential surface of the electric cylinder 130.

As illustrated in FIGS. 13B and 13C, in the thrust expansion device 1c, screw holes 401 penetrating therethrough are formed at two locations at positions on both outsides in the radial direction with respect to the orthogonal input recessed portion 272 in the elongated orthogonal surface portion 271.

Although FIGS. 13A to 13C illustrate a case in which the thrust expansion device 1c is attached to the articulated robot arm 200, the screw hole 401 is used when the thrust expansion device 1c is fixed to a work table or the like by bolts.

Next, an operation of the thrust expansion device 1c in the third embodiment will be described.

A basic operation of the thrust expansion device 1c is the same as those in the first embodiment and the second embodiment.

That is, the thrust Fi input by the input rods 101 and 103 entering the hydraulic chambers 8a to 8c is expanded to the thrust Fp according to the Equation (1) described above and output from the front end of the output rod 72.

When a plurality of input cylinders are attached to the thrust expansion device, the stroke (hydraulic stroke OS) of the output rod 72 is determined by a total volume of the input rods of the input cylinders inserted into the hydraulic chamber 8. When the air cylinder 100 and the electric cylinder 130 are attached to the thrust expansion device 1c as in the third embodiment, the hydraulic stroke OS of the output rod 72 is determined by a sum (total insertion volume) of the insertion volume of the input rod 101 into the hydraulic chamber 8b and the insertion volume of the input rod 131 into the hydraulic chamber 8c.

In this way, by attaching a plurality of input cylinders (input actuators) to the thrust expansion device 1c and increasing the total insertion volume of respective input rods inserted into the hydraulic chambers 8a to 8c, the hydraulic stroke OS of the output rod 72 can be increased.

The pressure generated by the plurality of input rods pressing the hydraulic chamber needs to be the same for all the input cylinders (input actuators) to be attached. In the example of the third embodiment, since both the input rod 101 and the input rod 131 enter the hydraulic chambers 8a to 8c, the pressure generated by pressing the hydraulic chamber 8b by the input rod 101 and the pressure generated by pressing the chamber 8c by the input rod 131 are necessary to the same.

That is, when the thrust input from the air cylinder 100 is Fia, an area of the front end of the input rod 101 is S1a, the thrust input from the electric cylinder 130 is Fie, and the area of the front end of the input rod 131 is S1e, it is necessary to satisfy the following Equation (3):

Fia/S1a=Fie/S1e

When the Equation (3) is satisfied, in order to output the amplified thrust from the output rod 72 of the thrust expansion device 1c, the order in which the air cylinder 100 and the electric cylinder 130 are driven is not questioned. That is, it is possible to operate a plurality of input cylinders attached to the thrust expansion device 1c at the same time or sequentially separately. A combination of a pneumatic pressure and electric motor is free and can be mixed.

When a plurality of air cylinders 100 are attached and the respective air cylinders 100 are sequentially operated, the output rod 72 is sequentially operated step by step with the amount of the hydraulic stroke OS corresponding to the stroke of each operating air cylinder 100.

However, when the air cylinder 100 and the electric cylinder 130 are attached as in the usage example of the thrust expansion device 1c illustrated in FIGS. 13A to 13C, it can be operated as follows by taking advantages of characteristics of each input cylinder.

That is, the input rod 101 of the air cylinder 100 has characteristics that a moving speed is fast but the accuracy of the amount of the movement is low. On the other hand, the input rod 131 of the electric cylinder 130 has characteristics that the moving speed is slower than that of the air cylinder 100 but the accuracy of the amount of the movement is high.

Therefore, the air cylinder 100 can be used first for coarse movement (coarse adjustment) with respect to the output rod 72, and then the electric cylinder 130 can be used for fine movement (precision feed and fine adjustment).

Therefore, with the hydraulic stroke OS in which the output rod 72 can move, the air cylinder 100 is quickly brought closer to the workpiece W, and then the electric cylinder 130 can output the thrust that is accurately expanded from the output rod 72 to the workpiece W.

A plurality of electric cylinders 130 may be used in place of the air cylinder 100 to selectively use for coarse movement and fine movement. An electric cylinder with coarse accuracy but fast operation may be used for coarse movement, and an electric cylinder with high precision for the fine movement may be used for fine movement.

When a plurality of input cylinders (input actuators) are attached to the thrust expansion device described above, a combination of input cylinders, operation sequence, effects (coarse and fine movements, and an increase in the hydraulic stroke OS due to an increase in a total insertion volume of the input rods), and the like are the same in each of the fourth and subsequent embodiments.

Next, a thrust expansion device 1d according to a fourth embodiment will be described.

In the third embodiment, one input cylinder can be attached to each of the opposite surface portion 261 and the orthogonal surface portion 271 with respect to the output surface portion 251 through which the output rod 72 enters and exits.

On the other hand, in the thrust expansion device 1d of the fourth embodiment, an orthogonal input recessed portion 272a and an orthogonal input recessed portion 272b are formed on both sides of an output recessed portion 252 with respect to an output surface portion 251 in an orthogonal surface portion 271. Therefore, two input cylinders are attached in parallel in the horizontal direction, and the both input rods move in a direction orthogonal to the axial direction of the output rod 72.

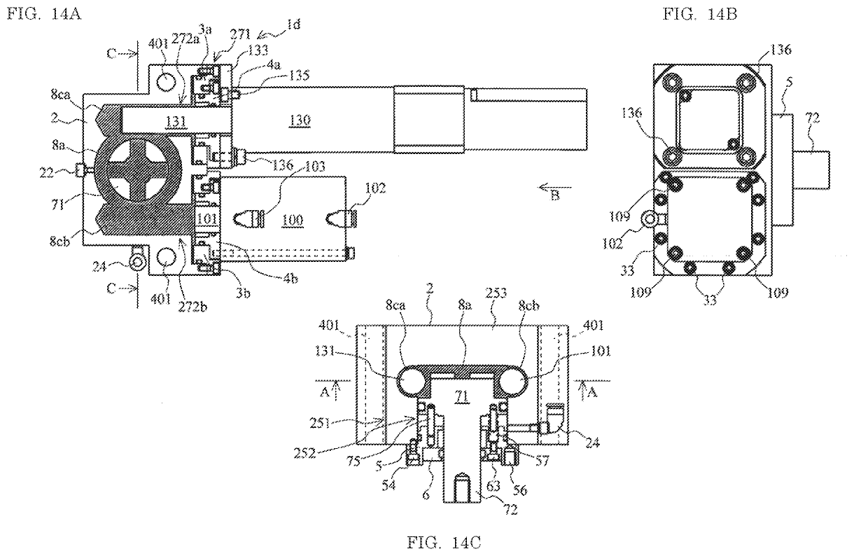

FIGS. 14A to 14C are explanatory views illustrating the thrust expansion device 1d according to the fourth embodiment, in which FIG. 14A is a cross-sectional view taken along line A-A in FIG. 14C, FIG. 14B is a view of the thrust expansion device 1d viewed in a direction of arrow B, and FIG. 14C is a cross-sectional view taken along line C-C in FIG. 14A. FIGS. 14A to 14C illustrate a state in which the electric cylinder 130 and the air cylinder 100 are attached in parallel in a direction orthogonal to the axial direction of the output rod 72. Although not illustrated, a bolt hole for attaching the robot adaptor 201 may be formed on a surface on the opposite side of the output surface portion 251 or on a surface on the opposite side of the orthogonal surface portion 271.

As illustrated in FIGS. 14A to 14C, the thrust expansion device 1d has the output recessed portion 252 in which the piston portion 71 and the output rod 72 are disposed inside the output surface portion 251, as in the other embodiments.

Since the opposite input recessed portion 262 is not formed in the cylinder 2 of the thrust expansion device 1d, the output recessed portion 252 has a bottom portion 253 as illustrated in an upper side of FIG. 14C.

In the thrust expansion device 1d of the present embodiment, the input rod of the input cylinder to be connected enters and exits a position and a direction different from the axis of the output rod 72. Therefore, no cavity portion (see the cavity portion 73 in FIGS. 1A to 1C) is formed at the axial position of the piston portion 71 and the output rod 72 disposed in the output recessed portion 252, but the cavity portion 73 may be disposed.

As illustrated in FIG. 14A, two orthogonal input recessed portions 272a and 272b are formed on the orthogonal surface portion 271 of the cylinder 2 in parallel on the same surface with the output recessed portion 252 in the center.

The orthogonal input recessed portions 272a and 272b are formed such that a bottom side thereof is connected to the output recessed portion 252. Therefore, a hydraulic chamber 8a in the output recessed portion 252, a hydraulic chamber 8ca in the orthogonal input recessed portion 272a, and a hydraulic chamber 8cb in the orthogonal input recessed portion 272b are in communication with each other. The orthogonal input recessed portions 272a and 272b are formed such that the orthogonal surface, which is an open surface, has an inner diameter in which the input-side lids 3a and 3b can be attached, as in the other embodiments. On the other hand, both bottom sides (back sides) of the orthogonal input recessed portions 272a and 272b are formed to have an inner diameter smaller than that of the open surface and larger than that of the input rods (input rods 101 and 131, and the like) of the input cylinder to be connected.

As illustrated in FIGS. 14A to 14C, the input-side lid 3 and the lid adaptor 4 are attached to both the orthogonal input recessed portions 272a and 272b of the orthogonal surface portion 271. The electric cylinder 130 is attached to the orthogonal input recessed portion 272a via the adaptor 133, and the air cylinder 100 is attached to the orthogonal input recessed portion 272b.

However, when a plurality of input cylinders are not required, the sealing lid 3T can be attached instead.

FIG. 14A illustrates a state (driving state) in which the input rod 131 of the electric cylinder 130 enters the hydraulic chamber 8ca.

When driving the thrust expansion device 1d, one or both of the air cylinder 100 and the electric cylinder 130 are driven, and the input rod 101 or/and the input rod 131 enter the hydraulic chambers 8ca and 8cb. Therefore, the piston portion 71 and the output rod 72 move in the output direction by a predetermined hydraulic stroke OS, and the thrust amplified by the hydraulic pressure is output from the front end of the output rod 72.

Next, a thrust expansion device 1e according to a fifth embodiment will be described.

In the thrust expansion device 1d of the fourth embodiment described above, two input cylinders can be disposed on the orthogonal surface portion 271 with respect to the output surface portion 251.

On the other hand, in the thrust expansion device 1e of the fifth embodiment, one input cylinder can be disposed on an orthogonal surface portion 271 and two input cylinders can be disposed on an opposite surface portion 261 with respect to an output surface portion 251.

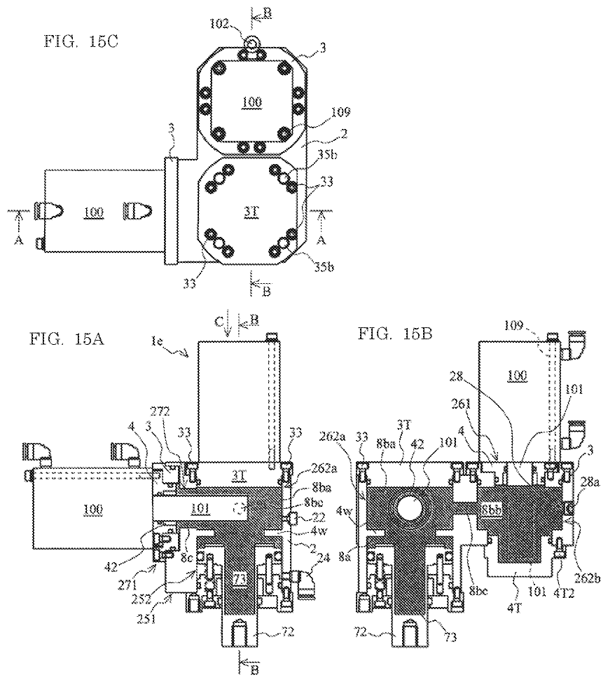

FIGS. 15A to 15C are explanatory views of the thrust expansion device 1e according to the fifth embodiment, in which FIG. 15A is a cross-sectional view taken along line A-A in FIG. 15C, FIG. 15B is a cross-sectional view taken along line B-B in FIG. 15A, and FIG. 15C is a view of the thrust expansion device 1e viewed in a direction of arrow C in FIG. 15A.

As described above, the thrust expansion device 1e can be provided with a maximum three input cylinders. However, in FIGS. 15A to 15C, a state in which one air cylinder 100 is disposed in each of the orthogonal surface portion 271 and the opposite input recessed portion 262 with respect to the output surface portion 251 is illustrated.

Inside the cylinder 2, an output recessed portion 252 is formed on the output surface portion 251, an opposite input recessed portion 262a and an opposite input recessed portion 262b are formed on the opposite surface portion 261, and an orthogonal input recessed portion 272 is formed in the orthogonal surface portion 271.

As the first embodiment, respective members such as a piston portion 71 and an output rod 72 are disposed inside the output recessed portion 252.

The output recessed portion 252 and the opposite input recessed portion 262a have the same axis and are formed to have the same diameter, and are partitioned by an abutting wall 4W and formed in the center as in the second embodiment (see FIGS. 13A to 13C) to communicate with each other by a through-hole. An input cylinder such as the air cylinder 100 can be attached after the input-side lid 3 and the lid adaptor 4 are attached to the open side of the opposite input recessed portion 262a. In the example illustrated in FIGS. 15A to 15C, a sealing lid 3T is attached to the open side of the opposite input recessed portion 262a. When the air cylinder 100 is attached to the opposite input recessed portion 262a, the input rod 101 enters a cavity portion 73 of an output rod 72 in the driving state.

As illustrated in FIGS. 15B and 15C, the cylinder 2 of the thrust expansion device 1e has the opposite surface portion 261 formed in a horizontally long shape, and opposite input recessed portion 262b is formed on the side spaced apart from the axis of the output rod 72.

The axis of the opposite input recessed portion 262a is formed at the same position as the axis of the output rod 72, whereas the axis of the opposite input recessed portion 262b is parallel to the axis of the output rod 72. The opposite input recessed portion 262b has a diameter larger than the diameter of the input-side lid 3 and is formed at a position shifted therefrom in the lateral direction. The opposite input recessed portion 262b is formed so as to penetrate the cylinder 2 as a whole, and a closing lid 4T having a recessed center is fixed to the cylinder 2 by a bolt 4T2. As illustrated by a dotted line in FIG. 15B, the recessed portion formed in the closing lid 4T is provided for securing a space where the input rod 101 of the air cylinder 100 does not abut against the recessed portion.

It is also possible to adopt a configuration in which the closing lid 4T is not provided by elongating the cylinder 2 of a portion where the opposite input recessed portion 262b is formed (output direction) and forming the opposite input recessed portion 262b in a bottomed shape.

An auxiliary hole 28 penetrating the cylinder 2 is formed on a side surface of the opposite input recessed portion 262b.

On an extension line of the auxiliary hole 28, a communication hole 8bc is formed, which communicates with the opposite input recessed portion 262a and the opposite input recessed portion 262b. The auxiliary hole 28 is a hole for inserting a drill when the communication hole 8bc is formed, and has an inner diameter larger than that of the communication hole 8bc.

The auxiliary hole 28 is sealed by the bolt 28a after the communication hole 8bc is formed.

As illustrated in FIG. 15A, an oil filler penetrating the cylinder 2 is formed and an oil filler plug 22 is disposed on the side surface of the opposite input recessed portion 262a. However, the auxiliary hole 28 may be used for filling with oil instead of the oil filler of the opposite input recessed portion 262a. In this case, the oil filler plug 22 after filling with oil is attached to the auxiliary hole 28.

The orthogonal input recessed portion 272 formed in the orthogonal surface portion 271 is in communication with the opposite input recessed portion 262a at the bottom portion. The input rod 101 of the air cylinder 100 disposed on the orthogonal surface portion 271 enters the opposite input recessed portion 262a.

Inside the thrust expansion device 1e, hydraulic chambers 8a, 8ba, 8bb, and 8c communicating with each other are respectively formed inside the output recessed portion 252, the opposite input recessed portion 262a, the opposite input recessed portion 262b, and the orthogonal input recessed portion 272. In other words, the cylinder 2 is formed with a hydraulic chamber 8bb (expansion fluid chamber) of which side surface portions disposed on the side surfaces of the opposite surface portion 261 and the output surface portion 251 are expanded more than other surface portions, and communicates with the hydraulic chambers 8a and 8ba (fluid chambers) via the communication hole 8bc in the cylinder 2.

In the thrust expansion device 1e, as illustrated in FIGS. 15A to 15C, the two air cylinders 100 are disposed at positions where both input rods 101 do not interfere with each other. Therefore, similarly to the fourth embodiment, both the air cylinders 100 can be operated at the same time or sequentially.

One or both of the air cylinders 100 may be connected in place of the electric cylinder 130.

It is also possible to remove one air cylinder 100 and attach the air cylinder 100 to the open side of the opposite input recessed portion 262a. In this case, the sealing lid 3T on the opposite input recessed portion 262a side is replaced with the input-side lid 3 and the lid adaptor 4 on the removed side.

However, when two air cylinders 100 are attached to the opposite surface portion 261, both input rods 101 do not interfere with each other, and therefore it is possible to operate the two input rods 101 at the same time. However, in the thrust expansion device 1e illustrated in FIGS. 15A to 15C, when the air cylinder 100 on the opposite input recessed portion 262b side is changed to the opposite input recessed portion 262a side, the two input rods 101 interfere with each other, so that the operation is limited to only one.

It is also possible to attach three input cylinders (air cylinder 100, electric cylinder 130, and the like) to the thrust expansion device 1e.

Also in this case, since the input cylinders attached to the orthogonal input recessed portion 272 and the opposite input recessed portion 262a interfere with each other, it is necessary to avoid simultaneous driving.

Next, a thrust expansion device 1f according to a sixth embodiment will be described.

In the thrust expansion device 1e of the fifth embodiment described above, in order to be able to dispose one input cylinder on the orthogonal surface portion 271 and two input cylinders on the opposite surface portion 261 in parallel with respect to the output surface portion 251, the cylinder 2 having a size approximately two times in the horizontal direction is used.

On the other hand, in the thrust expansion device 1f of the sixth embodiment, an output unit 1X having an output surface portion 251 in which a piston portion 71 and an output rod 72 are disposed, and an expansion unit 1Y not having the output surface portion 251 are connected by a connecting unit 400. Therefore, two input cylinders per unit can be disposed on the opposite surface portion 261.

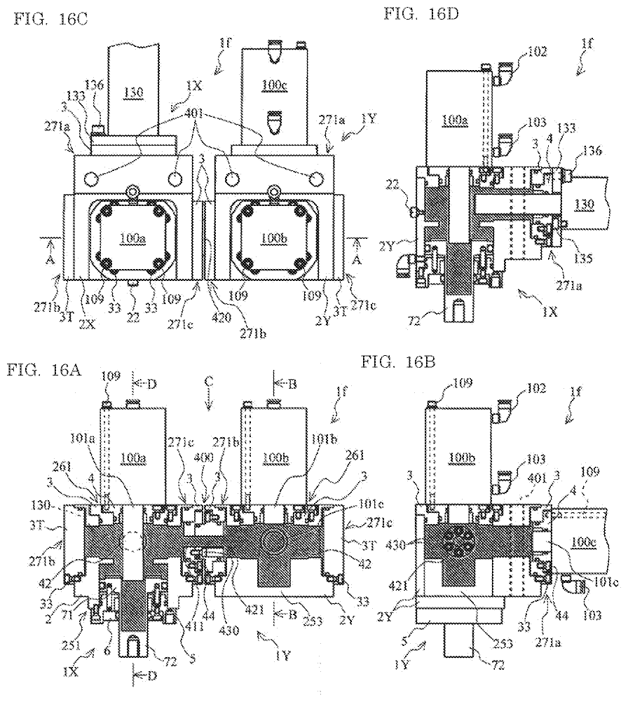

FIGS. 16A to 16D are explanatory views illustrating the thrust expansion device 1f according to the sixth embodiment, in which FIG. 16A is a cross-sectional view taken along line A-A in FIG. 16C, FIG. 16B is a cross-sectional view taken along line B-B in FIG. 16A, FIG. 16C is a view of the thrust expansion device 1f viewed in a direction of arrow C in FIG. 16A, and FIG. 16D is a cross-sectional view taken along line D-D in FIG. 16A.

In the thrust expansion device 1f illustrated in FIGS. 16A to 16D, a case in which three air cylinders 100 and one electric cylinder 130 are attached is illustrated. The three air cylinders 100 are distinguished from each other by their reference numerals 100a, 100b, and 100c depending on their disposition positions.

As illustrated in FIGS. 16A to 16D, the thrust expansion device 1f includes an output unit 1X and an expansion unit 1Y, and they are connected by a connecting unit 400. Details of the connecting unit 400 will be described later.

As illustrated in FIG. 16A, the output unit 1X includes an air cylinder 100a as an input actuator and a cylinder 2X that functions as an output portion of the thrust expansion device. An output surface portion 251 is formed where a piston portion 71, an output rod 72, and the like are disposed inside the cylinder 2X. The expansion unit 1Y is formed of an air cylinder 100b as an input actuator and a cylinder case (expansion cylinder) 2Y having only a function of converting an input thrust into an expanded hydraulic pressure.

The output unit 1X includes orthogonal surface portions 271a to 271c (see FIG. 16C) formed at three locations of the orthogonal surfaces of four locations with respect to the output surface portion 251, and an opposite surface portion 261 (see FIG. 16A). However, all the surfaces orthogonal to the output surface portion 251 can be the orthogonal surface portions 271. In this case, it is necessary to provide an oil filler on any one of the opposite surface portion 261 and the orthogonal surface portion 271 or on a lid member such as an input-side lid 3 or a sealing lid 3T attached thereto.

An inner diameter and an end surface portion of an open end side of the opposite input recessed portion 262 of the opposite surface portion 261 and the orthogonal input recessed portions 272 (reference numerals 262 and 272 are not illustrated) of the orthogonal surface portions 271a to 271c at three locations are formed in the same size and shape as in the other embodiments. The input-side lid 3, the sealing lid 3T, and the connecting unit 400 can be also attached to any open end side.

One of the three orthogonal surface portions 271a to 271c of the output unit 1X is used for attaching the input cylinder. In the example of FIGS. 16A to 16D, the electric cylinder 130 is attached via the input-side lid 3, the lid adaptor 4, and the adaptor 133.

In the output unit 1X, in a state in which the air cylinder 100a and the electric cylinder 130 attached to the opposite surface portion 261 are operated, lengths (in the axial direction) of the orthogonal surface portion 271a and the orthogonal input recessed portion 272 are longer than the working distance of the input rod 131. Therefore, the front end of the input rod 131 does not come into contact with the circumferential surface of the air cylinder 100a.

In order to avoid the positional relationship between the input rod 101 and the input rod 131, and the contact between the both rods 101 and 131, the orthogonal surface portion 271a is formed long in the axial direction of the orthogonal input recessed portion 272. This is the same as the thrust expansion device 1c of the third embodiment described with reference to FIGS. 13A to 13C.

Therefore, compared with the shape of the thrust expansion device 1c (FIGS. 13A to 13C), the shape of the output unit 1X is formed such that the thickness of both sides (in the case of the thrust expansion device 1c in FIGS. 13A to 13C, the surface side to which the robot adaptor 201 is attached and the opposite side) of the orthogonal surface portion 271a, to which the electric cylinder 130 is attached, is thickly formed by an amount fixed by the pressing bolt 33. The shape is substantially the same except that the orthogonal surface portions 271b and 271c, and the orthogonal input recessed portion 272 are formed, and the disposition positions of the oil filler and the oil filler plug 22 are different.

In the output unit 1X, since the orthogonal surface portions 271a to 271 c are formed on three surfaces, the oil filler and the oil filler plug 22 are formed on a surface where the orthogonal surface portion 271 is not formed.

The elongated orthogonal surface portion 271a of the output unit 1X has screw holes 401 penetrating at two locations for fixing to a work table or the like, similarly to that of the thrust expansion device 1c of the third embodiment.

On the other hand, the expansion unit 1Y is formed in substantially the same manner as the output unit 1X except that the output surface portion 251 and the output recessed portion 252 do not exist and the piston portion 71 and the output rod 72 are also not disposed.

In the expansion unit 1Y, since the output recessed portion 252 is not formed, a portion corresponding to the output surface portion 251 is closed by a bottom portion 253. The opposite surface portion 261 is formed on a surface side opposite to the bottom portion 253.

The expansion unit 1Y has orthogonal surface portions 271a to 271c (see FIG. 16C) formed at three locations of the orthogonal surfaces of four locations with respect to the bottom portion 253, and the oil filler plug 22 is provided at the remaining one location. However, the orthogonal surface portions 271 may be formed on all the orthogonal surfaces of four locations. In this case, the sealing lid 3T may be attached to at least one location, and the oil filler plug 22 may be provided in the sealing lid 3T.

The inner diameter and end surface portion of the open end side of the opposite input recessed portion 262 of the opposite surface portion 261 and the orthogonal input recessed portions 272 (reference numerals 262 and 272 are not illustrated) of the orthogonal surface portions 271a to 271c at three locations are formed in the same size and shape similarly to those of the output unit 1X. Therefore, the input-side lid 3 (expansion input-side lid) and the sealing lid 3T (expansion sealing lid) can be attached to any open end side.

Each of the input-side lids 3 is fixed to the orthogonal surface portion 271c of the output unit 1X and the orthogonal surface portion 271b of the expansion unit 1Y, and is connected by the connecting unit 400 described later.

On the other hand, the orthogonal surface portion 271b of the output unit 1X and the orthogonal surface portion 271c of the expansion unit 1Y are sealed by the respective sealing lids 3T.

The electric cylinder 130 is attached to the orthogonal surface portion 271a of the output unit 1X via the input-side lid 3, the lid adaptor 4, and the adaptor 133.

The input-side lid 3 and the lid adaptor 4 are attached to the opposite surface portion 261 of the output unit 1X, the opposite surface portion 261 of the expansion unit 1Y, and the orthogonal surface portion 271a of the expansion unit 1Y. The air cylinders 100a, 100b, and 100c are attached thereto.

Similarly to the output recessed portion 252, the opposite input recessed portion 262, and the orthogonal input recessed portion 272 described in the first to the fifth embodiments, recessed portions, which communicate with each other, are formed inside the output surface portion 251, the opposite surface portion 261, and the orthogonal surface portions 271a to 271c in the output unit 1X and the expansion unit 1Y.

In the communicating recessed portion, a hydraulic chamber filled with oil is formed as in the other embodiments. The output unit 1X and the expansion unit 1Y are in communication with each other through through-holes 411 and 421 formed in the connecting unit 400, as illustrated in FIG. 16A.

In FIGS. 16A to 16D, as in FIGS. 3A to 6B, the oil-filled region is represented by a solid color.

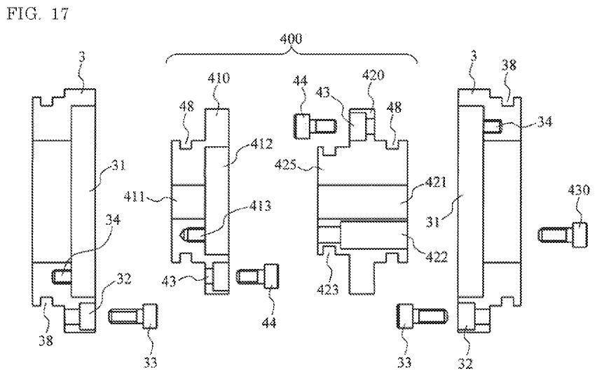

FIG. 17 illustrates each part of the connecting unit 400 and two input-side lids 3 to which the connecting unit 400 is attached. However, the O-ring illustrated in FIGS. 16A to 16D is not displayed in FIG. 17.

Two input-side lids 3 displayed on the left and right in FIG. 17 are the same as the input-side lid 3 described in FIGS. 1A to 2. However, the screw hole 35 indicated by a dotted line in FIG. 2 is not illustrated. The screw hole 35 is formed to fix the air cylinder 100 or the like by the pressing bolt 109 or the like, and is formed to share the input-side lid 3, but it may be omitted when being used for the connecting unit 400.

The input-side lid 3 on the left side of the drawing is attached to the orthogonal surface portion 271c of the output unit 1X by a pressing bolt 33, and the input-side lid 3 on the right side is similarly attached to the orthogonal surface portion 271b of the expansion unit 1Y by the pressing bolt 33.

As illustrated in FIG. 17, the connecting unit 400 includes a lid adaptor 410 attached to the input-side lid 3 of the output unit 1X and a lid adaptor 420 attached to the input-side lid 3 of the expansion unit 1Y.

An external shape of the lid adaptor 410 is the same as that of the lid adaptor 4 described with reference to FIGS. 1A to 2, and is the same as that disposed in the through-hole 31 formed in the input-side lid 3.

The through-hole 43 and an outer circumferential groove 48 for attaching the lid adaptor 410 to the input-side lid 3 by the pressing bolt 44 are also the same.

On the other hand, unlike the lid adaptor 4, a recessed portion 412 is formed inside the lid adaptor 410 at a center portion on a flange side (expansion unit 1Y side). A part of the lid adaptor 420 is inserted into the recessed portion 412.

A through-hole 411 for communicating with the hydraulic chambers on the output unit 1X side and the expansion unit 1Y side is formed at the center of the recessed portion 412.

Bolt holes 413 are formed at six locations on the bottom surface (outside the through-hole 411 in the radial direction) of the recessed portion 412 (only one location is illustrated in FIG. 17).

The lid adaptor 420 includes the same external shape portion as that of the lid adaptor 4 in which the outer circumferential groove 48 and the through-hole 43 are formed, and a protruding portion 425 having a circular cross section formed at the center on the opposite side of the outer circumferential groove 48.

An outer diameter of the protruding portion 425 is formed slightly smaller than the inner diameter of the recessed portion 412 of the lid adaptor 410 to be inserted into the recessed portion 412 (see FIG. 16A). A circumferential groove 423 is formed on an outer periphery of the protruding portion 425, and the oil in the hydraulic chamber is sealed by an O-ring.

The lid adaptor 420 is formed with a through-hole 421 that penetrates the center and is connected to the through-hole 411 of the lid adaptor 410 by attachment.

On the outside of the through-hole 421 in the radial direction, through-holes 422 are formed at six locations corresponding to the bolt holes 413 at six locations formed in the lid adaptor 410. The through-hole 422 has a stepped portion formed by reducing the inner diameter on the lid adaptor 410 side, and a head portion of the connecting bolt 430 comes into contact with and is fixed to the stepped portion.

The connection of the output unit 1X and the expansion unit 1Y by the connecting unit 400 is as follows.

The input-side lid 3 is fixed to the orthogonal surface portion 271c of the output unit 1X by the pressing bolt 33, and the lid adaptor 410 is inserted into the through-hole 31 of the input-side lid 3 and fixed thereto by the pressing bolt 44.

The input-side lid 3 is fixed to the orthogonal surface portion 271b of the expansion unit 1Y by the pressing bolt 33, and the lid adaptor 420 is inserted into the through-hole 31 of the input-side lid 3 and fixed thereto by the pressing bolt 44.

The protruding portion 425 of the lid adaptor 420 is inserted into the recessed portion 412 of the lid adaptor 410, and is fixed to the bolt hole 413 by six connecting bolts 430 (see FIGS. 16A and 16B). The connecting bolt 430 is inserted into the through-hole 422 from the orthogonal surface portion 271c side and fixed to the bolt hole 413 before attaching the sealing lid 3T (expansion sealing lid) to the expansion unit 1Y.

As described above, according to the thrust expansion device 1f of the sixth embodiment, the output unit 1X and the expansion unit 1Y are connected by the connecting unit 400, so that a total four cylinders of three air cylinders 100a to 100c and one electric cylinder 130 can be disposed. By providing four input cylinders, a larger stroke OS (see FIGS. 3A to 3D) for the output rod 72 can be secured.

Since the input rods 101a to 101c, and 131 of the respective input cylinders can be operated without interfering with each other, the input cylinders can be operated at the same time, or individually and sequentially.

As described above, the air cylinders 100a to 100c can ensure (coarse adjustment) a large amount of hydraulic stroke of the output rod 72, and the electric cylinder 130 can perform fine adjustment.

In the thrust expansion device 1f, it is also possible to change the attachment position by replacing the lid adaptor 4 and the air cylinder 100b attached to the opposite surface portion 261 of the expansion unit 1Y with the sealing lid 3T of the orthogonal surface portion 271c. Also in this case, since respective input rods do not interfere with each other, respective input cylinders can be operated in an arbitrary order.

The air cylinder 100c disposed on the orthogonal surface portion 271a of the expansion unit 1Y can be replaced with the orthogonal surface portion 271c.

In addition to the state of the thrust expansion device 1f, the air cylinders 100d and 100e can be attached to the orthogonal surface portion 271b of the output unit 1X and/or the orthogonal surface portion 271c of the expansion unit 1Y.

However, in both modified examples, there is a combination in which the input rods 101 and 131 interfere with each other. Therefore, it is necessary to limit the operations of the input cylinders between the interfering input rods 101 and 131 to any one operation.

One or more of the air cylinders 100a to 100c are changed to other input cylinders such as the electric cylinder 130 and the air cylinder 120 with respect to the thrust expansion device if described in the sixth embodiment, and the electric cylinder 130 can be changed to other air cylinders 100 and 120, and the like.

Next, thrust expansion devices 1g and 1h according to seventh and eighth embodiments will be described.

In the thrust expansion device 1f of the sixth embodiment, the case in which one output unit 1X and one expansion unit 1Y are connected by the connecting unit 400 is described.

On the other hand, in the seventh and eighth embodiments, a total of three or more output units 1X and expansion units 1Y are connected by a connecting unit 400, so that more input cylinders can be attached and more output can be obtained.

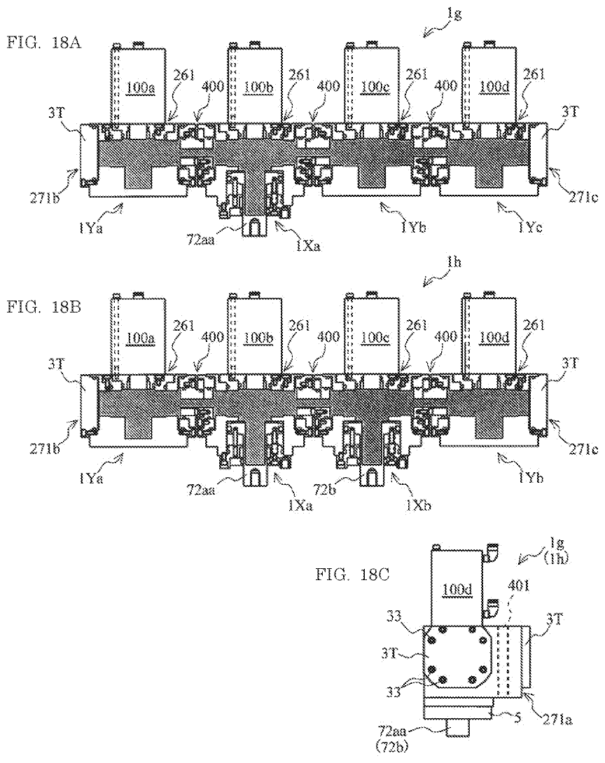

FIGS. 18A to 18C are explanatory views of the seventh and the eighth embodiments of the thrust expansion device.

FIGS. 18A and 18B illustrate cross sections (excluding the input cylinder) along a longitudinal direction of the thrust expansion devices 1g and 1h, and FIG. 18C illustrates a state in which the thrust expansion devices 1g and 1h are viewed from the right side.

In the thrust expansion device 1g illustrated in FIG. 18A, one expansion unit 1Ya, one output unit 1Xa, two expansion units 1Yb and 1Yc are disposed in a straight line from the left side of the drawing, and they are connected to each other by the connecting units 400.

Each end portion of the expansion units 1Ya and 1Yc disposed at both ends is sealed by the sealing lid 3T.

In the present embodiment, as illustrated in FIG. 18A, air cylinders 100a to 100d are connected to the opposite surface portion 261, and as illustrated in FIG. 18C, the sealing lids 3T are connected to the orthogonal surface portions 271 at four locations.

In the thrust expansion device 1h illustrated in FIG. 18B, two output units 1Xa and 1Xb are connected by the connecting unit 400, and respective expansion units 1Ya and 1Yb on the outer side are further connected by the connecting units 400. The end portions of the expansion units 1Ya and 1Yb on both ends are sealed by the respective sealing lids 3T.

In the thrust expansion device 1h, as illustrated in FIG. 18B, all the air cylinders 100a to 100d are connected to the opposite surface portion 261, and as illustrated in FIG. 18C, the sealing lids 3T are connected to the orthogonal surface portions 271 at four locations.

Compared to the thrust expansion device 1g, in the thrust expansion device 1h, two output units 1Xa and 1Xb are connected, so that the hydraulic stroke OS of the output rods 72aa and 72b is halved, but an amplified thrust from two locations of the output rods 72aa and 72b can be output.

Therefore, for example, a plurality of workpieces can be processed at the same time by attaching the output attachment 300 described in FIG. 7 and a caulking tool 72A and a caulking tool 308A for caulking to the output units 1Xa and 1Xb.

When the output attachment 300 of different working or an assembling step is attached to the output units 1Xa and 1Xb, working or assembling of different step can be performed by one device at a time.

It is possible to use a mixture of the working step and the assembling step.

For example, a working attachment and an assembling attachment are respectively attached to the output units 1Xa and 1Xb. A drilling attachment is attached to the output unit 1Xa to perform drilling, and a press-fit attachment of a pin is attached to the output unit 1Xb. It is possible to perform the assembling step in which a hole is made in the workpiece by the output unit 1Xa as a first step, and then the workpiece is moved to the output unit 1Xb, and the pin is press-fitted into the opened hole made by the output unit 1Xb as a second step. In this manner, the pin can be press-fitted by the output unit 1Xb into the workpiece that is drilled by the output unit 1Xa, and at the same time, a hole can be machined into a next workpiece by the output unit 1Xa. According to the output attachment of the present invention, it is possible to provide a thrust expansion device capable of reducing a work time.

In the seventh and the eighth embodiments, and the second to the sixth embodiments, the input-side lid 3 is attached in place of the sealing lid 3T, and a robot adaptor is attached to the input-side lid 3 instead of the lid adaptor 4. Therefore, it is possible to attach the thrust expansion device to the articulated robot arm 200.

However, the robot adaptor 201 described in FIGS. 7A to 7F has a rectangular shape, and four corners thereof are fixed to the cylinder 2 by the pressing bolts 206. The robot adaptor attached to the input-side lid 3 is fixed to the input-side lid 3 by using the screw hole 35 of the input-side lid 3.

According to the thrust expansion devices 1g and 1h of the seventh and the eighth embodiments, the four air cylinders 100a to 100d can be disposed on the opposite surface portion 261 in a straight line. By disposing the input cylinders such as the air cylinder 100 and the electric cylinder 130 on the orthogonal surface portions 271a at four locations, a maximum of eight input cylinders can be connected without interference of the input rod 101.

FIGS. 18A to 18C illustrate a case in which all the air cylinders 100 are connected. However, regardless of types of eight input cylinders that can be connected, it is possible to connect all the air cylinders 100, all the electric cylinders 130, or the air cylinders 100 and the electric cylinders 130.

In FIGS. 18A to 18C, it is also possible to connect the input cylinders to the orthogonal surface portions 271b and 271c of the expansion units 1Ya and 1Yc disposed at both ends.

In the seventh and the eighth embodiments, a case in which a total of four output units 1X and expansion units 1Y are connected is described. However, a total of three units can be connected, or five or more units can be connected. However, it is necessary to include at least one output unit 1X.

Furthermore, in the seventh and the eighth embodiments, a case in which the output unit 1X and the expansion unit 1Y connected by the connecting unit 400 are disposed in a straight line is described. However, since there are the orthogonal surface portions 271a to 271c at three locations, the connection can be performed in an L shape or other shapes, and the connection can be performed so as to be branched on the way.

As described above, according to the thrust expansion devices 1g and 1h of the present embodiments, since it is separated and independent from the input-side actuator, a wide variety of actuators can be easily attached and replaced, and there is no need to have dedicated or integral actuator. Various inexpensive commercially available actuators can be easily attached and replaced.

It is possible to easily expand the thrust of various actuators by attaching various actuators having not only the air cylinder but also the electric type cylinder and other driving sources to the thrust expansion device 1b.

Various sizes and outputs of the input-side actuators can be easily changed later, a final performance of the output rod can be easily changed, and convenience can be improved.

Further, the following effects can be obtained by the embodiments described above:

(a) Since the fixing means for fixing the plurality of input actuators is provided, the plurality of input actuators can be attached at the same time.

(b) With respect to the plurality of actuators, the air cylinder and the electric cylinder can be attached at the same time.

(c) Since the input actuator can be attached to the output rod at an inclination angle, the height of the device can be reduced.

(d) The amount of operation of the output rod can be easily increased or decreased according to the number of input actuators to be assembled.

(e) Since the fixing means for fixing the plurality of input actuators is provided, the output rod can be operated in various ways by devising an operation sequence and an operation method of the input actuators.

For example, a stepwise operation is possible by sequentially operating the plurality of input actuators.

For example, the fine movement can be performed after the coarse movement:

(f) The input actuator and the output rod can be easily increased and decreased by increasing and decreasing the number of thrust expansion devices and expansion units connected by the connecting unit.

(g) In a case of having a plurality of thrust expansion devices, a plurality of working or assembling steps can be performed by one device by attaching attachments of different steps to each thrust expansion device.

(h) In a case of having a plurality of thrust expansion devices, the working step and the assembling step can be performed by one device by attaching the working attachment and the assembling attachment to each thrust expansion device.

As mentioned above, although the various thrust expansion devices and the usage examples of the present embodiment were described, it is also possible to constitute a thrust expansion device as follows.

### (1) Configuration 1

A thrust expansion device that expands and outputs a thrust input from an input actuator by connecting the input actuator to an input side, the device including a cylinder; a fluid piston having a piston portion disposed in the cylinder and moving in a thrust direction in the cylinder, and an output rod connected to the piston portion; an output-side lid portion connected to one end side of the cylinder and provided with a through-hole in which the output rod moves in the thrust direction; an input-side lid portion connected to the other end side of the cylinder and provided with an input portion into which the thrust from the input actuator is input; fluid supply means for supplying a fluid into a fluid chamber partitioned by the cylinder, the piston portion, and the input-side lid portion; and fixing means for fixing the input actuator, which is disposed at at least one location of the cylinder, the output-side lid portion, and the input-side lid portion.

### (2) Configuration 2

In the thrust expansion device of the configuration 1, the input-side lid includes an input-side lid where a replacing input portion is formed at a center, and which is fixed to the cylinder, and a lid adaptor where the input portion is formed at a center, and which is disposed in the replacing input portion of the input-side lid, and is fixed in a replaceable manner.

### (3) Configuration 3

In the thrust expansion device of the configuration 1 or 2, the fixing means includes fixing bolt holes formed in the input-side lid portion.

### (4) Configuration 4

In the thrust expansion device of the configuration 1, 2, or 3, the fixing means includes fixing bolt holes formed on side surfaces of the input-side lid portion and the output-side lid portion.

### (5) Configuration 5

In the thrust expansion device of any one of the configurations 1 to 4, the fluid piston includes a bottomed cavity portion extending from the piston portion to a middle of the output rod and forming a part of the fluid chamber.

### (6) Configuration 6

In the thrust expansion device of any one of the configurations 1 to 5, the fixing means includes a bolt hole for fixing a fixing adaptor for fixing the input actuator via the fixing adaptor.

### (7) Configuration 7

In the thrust expansion device of the configuration 6, the fixing means fixes the input actuator, at a position spaced apart from an input-side lid by a predetermined distance via the fixing adaptor.

### (8) Configuration 8

In the thrust expansion device of the configuration 7, the fixing means fixes the input actuator where an adaptor rod is fixed to a front end of the input rod of the input actuator, at a position spaced apart by the predetermined distance via the fixing adaptor.

### (9) Configuration 9

In the thrust expansion device of the configuration 8, the input portion formed on the input-side lid portion has a circular shape that matches a cross sectional shape of the adaptor rod fixed to the front end of the input actuator.

### (10) Configuration 10

In the thrust expansion device of any one of the configurations 1 to 7, the input portion formed on the input-side lid portion has a circular shape that matches a cross sectional shape of an input rod of the input actuator.

### (11) Configuration 11

In the thrust expansion device of any one of the configurations 1 to 10, the input actuator to be fixed by the fixing means is an air cylinder or an electric cylinder.

### (12) Configuration 12

In the thrust expansion device of the configuration 11, the input rod of the input actuator has a circular cross sectional shape with no level difference on an outer circumferential surface thereof.

### (13) Configuration 13

In the thrust expansion device of any one of the configurations 1 to 12, the output-side lid portion has a rotation stop member that restricts rotation of the piston with respect to the output-side lid portion.

### (14) Configuration 14

In the thrust expansion device of any one of the configurations 1 to 13, the thrust expansion device further includes biasing means for applying a force to the fluid piston in a direction toward the input side.

### (15) Configuration 15

In the thrust expansion device of any one of the configurations 1 to 14, the output-side lid portion includes an output-side lid where a replacing output portion is formed at a center and which is fixed to the cylinder, and a stop lid where the through-hole is formed at a center and which is disposed on the replacing output portion of the output-side lid and is fixed in a replaceable manner.

### (16) Configuration 16

In the thrust expansion device of the configuration 15, the thrust expansion device further includes output fixing means for fixing an output attachment, disposed at at least one location of the cylinder, the output-side lid portion, and the input-side lid portion, and receiving an expanded thrust output from the output rod.

### (17) Configuration 17

In the thrust expansion device of the configuration 16, the thrust expansion device further includes the output attachment capable of replacing a working jig corresponding to a working step.

### (18) Configuration 18

In the thrust expansion device of the configuration 16, the thrust expansion device further includes the output attachment capable of replacing gripping means for gripping a workpiece according to a workpiece shape.

### (19) Configuration 19

In the thrust expansion device of any one of the configurations 15 to 18, the thrust expansion device further includes robot fixing means for fixing a robot adaptor for attaching a robot arm, which is disposed at at least one location of the cylinder, the output-side lid portion, and the input-side lid portion.

### (20) Configuration 20

In the thrust expansion device of any one of the configurations 1 to 19, the fixing means fixes the input actuator so that an axis of an input rod of the input actuator that inputs a thrust to the input portion has a predetermined inclination angle with respect to an axis of the output rod.

### (21) Configuration 21

In the thrust expansion device of the configuration 20, the input-side lid portion is connected to the cylinder at the predetermined inclination angle with respect to the output-side lid portion.

### (22) Configuration 22

In the thrust expansion device of the configuration 20 or 21, the inclination angle is 90 degrees.

### (23) Configuration 23

A thrust expansion device including an input actuator having a cylindrical input rod; a cylinder; a fluid piston having a piston portion disposed in the cylinder and moving in a thrust direction in the cylinder, and an output rod connected to the piston portion; an output-side lid portion connected to one end side of the cylinder and provided with a through-hole in which the output rod moves in the thrust direction; an input-side lid portion connected to the other end side of the cylinder and provided with an input portion to which the thrust from the input actuator is input; fluid supply means for supplying a fluid into a fluid chamber partitioned by the cylinder, the piston portion, and the input-side lid portion; and fixing means for fixing the input actuator, which is disposed at at least one location of the cylinder, the output-side lid portion, and the input-side lid portion. The input actuator is connected by the input rod through the input-side lid portion to expand and output the thrust input from the input actuator.

What is claimed is:

1. A thrust expansion device that expands and outputs a thrust input from an input actuator by connecting the input actuator to an input side, the device comprising:
a cylinder including an output surface portion having a predetermined output surface, an opposite surface portion disposed to be opposite to the output surface portion, and a plurality of side surface portions disposed on a side of the output surface portion;
an output recessed portion constituting a part of a fluid chamber and being formed on the output surface portion;
a fluid piston including a piston portion disposed in the output recessed portion and moving in a thrust direction in the cylinder, and an output rod connected to the piston portion and outputting the thrust;
an output-side lid portion connected to the output recessed portion and having a through-hole in which the output rod moves in the thrust direction;
an input recessed portion constituting a part of the fluid chamber, communicating with the fluid chamber of the output recessed portion, and being formed at at least two locations of the opposite surface portion and the plurality of side surface portions; and
an input-side lid disposed at at least one location of an open end of the input recessed portion and having a through-hole formed at a center.

2. The thrust expansion device according to claim 1, further comprising a sealing lid which is disposed on an open end side where the input-side lid is not disposed in the open end and seals an open surface.

3. The thrust expansion device according to claim 2, wherein the input recessed portion includes one opposite input recessed portion formed on the opposite surface portion, and a side surface input recessed portion formed at at least one location of the plurality of side surface portions.

4. The thrust expansion device according to claim 1, wherein inner circumferential surfaces of the plurality of input recessed portions on an open end side are formed in the same shape at at least two locations.

5. The thrust expansion device according to claim 1, further comprising an adaptor which is disposed at at least one location of the input-side lid and to which the input actuator is connected, or which is disposed at at least one location of the input-side lid or the cylinder and to which another device such as a robot is connected.

6. The thrust expansion device according to claim 1, wherein the input recessed portion of the side surface portion is formed in a direction orthogonal to or inclined with respect to the output surface portion.

7. The thrust expansion device according to claim 1, further comprising fluid supply means for supplying fluid into the fluid chamber partitioned by inner circumferential surfaces of the output recessed portion and the input recessed portion communicating with each other, the piston portion, the input-side lid, and the sealing lid.

8. The thrust expansion device according to claim 1, wherein the cylinder includes a plurality of side surface portions orthogonal to the output surface portion, and
wherein the plurality of input recessed portions are formed only on the side surface portion.

9. The thrust expansion device according to claim 1, wherein a plurality of input recessed portions are formed at at least one same surface portion in the opposite surface portion or the side surface portion.

10. The thrust expansion device according to claim 1, wherein the cylinder includes an expansion fluid chamber formed by expanding at least one surface portion of the opposite surface portion and the side surface portion further from the other surface portion, and communicating with the fluid chamber in the cylinder, and
wherein the input recessed portion is formed on the expanded surface portion.

11. The thrust expansion device according to claim 1, wherein the input-side lid is disposed at two or more locations.

12. The thrust expansion device according to claim 11, wherein the opposite surface portion or/and the side surface portion on which the input-side lid is disposed are formed with a length with which interference does not occur or at a position at which interference does not occur between input rods of the input actuators that enter the cylinder from the input-side lid, and between the input rod and the fluid piston.

13. The thrust expansion device according to claim 12, wherein the input actuator connected to the input-side lid is an air cylinder or an electric cylinder.

14. The thrust expansion device according to claim 13, wherein the input rod of the input actuator has a circular cross section with no step on an outer circumferential surface.

15. The thrust expansion device according to claim 1, further comprising output fixing means disposed at at least one location of the cylinder, the output-side lid portion, and the input-side lid for fixing an output attachment that receives an expanded thrust output from the output rod,
wherein the output attachment is a replaceable working jig corresponding to a working step or a replaceable assembling jig corresponding to an assembling step.

16. A thrust expansion unit that is connected to the input-side lid disposed at the open end of the thrust expansion device according to claim 1, and transmits a thrust from an input actuator, the thrust expansion unit comprising:
an expansion cylinder which includes a bottom surface portion having a bottom portion, an expansion opposite surface portion disposed to be opposite to the bottom surface portion, and a plurality of expansion side surface portions disposed on a side of the bottom surface portion, and in which one location of the expansion opposite surface portion or the expansion side surface portion and the input-side lid are connected;
an expansion input recessed portion constituting a part of the fluid chamber, communicating with the fluid chamber of the thrust expansion device, and being formed at at least two locations of the expansion opposite surface portion and the plurality of expansion side surface portions;
an expansion input-side lid which is not connected to the input-side lid of the thrust expansion device, is disposed at at least one location of an open end of the expansion input recessed portion, and has a through-hole formed at a center; and
an expansion sealing lid which is disposed on an open end side where the expansion input-side lid is not disposed in the open end and seals an open surface.

17. The expansion unit according to claim 16, wherein the expansion input recessed portion constituting a part of the fluid chamber is formed on the bottom surface portion.

18. The expansion unit according to claim 16, further comprising an adaptor disposed at at least one location of the expansion input-side lid, and connected to any one of the input actuator, the thrust expansion device, and another expansion unit, or is disposed at at least one location of the expansion input-side lid or the expansion cylinder, and connected to another device such as a robot.

19. The expansion unit according to claim 16, wherein inner circumferential surfaces of the plurality of expansion input recessed portions on the open end side are formed in the same shape as the input recessed portion of the thrust expansion device.

20. A connecting unit which is connected to two input recessed portions opposite to each other of which inner circumferential surfaces on an open end side are the same so as to connect two thrust expansion devices according to claim 4, the connecting unit comprising a through-hole through which both of the fluid chambers connected to each other communicate with each other.

21. A thrust expansion system comprising at least one thrust expansion device that expands and outputs a thrust input from an input actuator by connecting the input actuator to an input side,
the device comprising:
a cylinder including an output surface portion having a predetermined output surface, an opposite surface portion disposed to be opposite to the output surface portion, and a plurality of side surface portions disposed on a side of the output surface portion;
an output recessed portion constituting a part of a fluid chamber and being formed on the output surface portion;
a fluid piston including a piston portion disposed in the output recessed portion and moving in a thrust direction in the cylinder, and an output rod connected to the piston portion and outputting the thrust;
an output-side lid portion connected to the output recessed portion and having a through-hole in which the output rod moves in the thrust direction,
an input recessed portion constituting a part of the fluid chamber, communicating with the fluid chamber of the output recessed portion, and being formed at at least two locations of the opposite surface portion and the plurality of side surface portions; and
an input-side lid disposed at at least one location of an open end of the input recessed portion and having a through-hole formed at a center,
wherein at least one expansion unit that is connected to the input-side lid disposed at the open end of the thrust expansion device, and transmits a thrust from an input actuator,
the thrust expansion unit comprising:
an expansion cylinder which includes a bottom surface portion having a bottom portion, an expansion opposite surface portion disposed to be opposite to the bottom surface portion, and a plurality of expansion side surface portions disposed on a side of the bottom surface portion, and in which one location of the expansion opposite surface portion or the expansion side surface portion and the input-side lid are connected;
an expansion input recessed portion constituting a part of the fluid chamber, communicating with the fluid chamber of the thrust expansion device, and being formed at at least two locations of the expansion opposite surface portion and the plurality of expansion side surface portions;
an expansion input-side lid which is not connected to the input-side lid of the thrust expansion device, is disposed at at least one location of an open end of the expansion input recessed portion, and has a through-hole formed at a center; and
an expansion sealing lid which is disposed on an open end side where the expansion input-side lid is not disposed in the open end and seals an open surface,
wherein inner circumferential surfaces of the plurality of expansion input recessed portions on the open end side are formed in the same shape as the input recessed portion of the thrust expansion device, and
the connecting unit according to claim 20 which is disposed between two thrust expansion devices, which are opposite to each other, and connects both respectively.

22. The thrust expansion system according to claim 21, further comprising an adaptor which is disposed at at least one location of the input-side lid, and to which the input actuator, the thrust expansion device, another expansion unit, and another device such as a robot are connected.

23. A thrust expansion system comprising:
a plurality of thrust expansion devices that expands and outputs a thrust input from an input actuator by connecting the input actuator to an input side,
the device comprising:
a cylinder including an output surface portion having a predetermined output surface, an opposite surface portion disposed to be opposite to the output surface portion, and a plurality of side surface portions disposed on a side of the output surface portion;
an output recessed portion constituting a part of a fluid chamber and being formed on the output surface portion;
a fluid piston including a piston portion disposed in the output recessed portion and moving in a thrust direction in the cylinder, and an output rod connected to the piston portion and outputting the thrust;
an output-side lid portion connected to the output recessed portion and having a through-hole in which the output rod moves in the thrust direction;
an input recessed portion constituting a part of the fluid chamber, communicating with the fluid chamber of the output recessed portion, and being formed at at least two locations of the opposite surface portion and the plurality of side surface portions;
an input-side lid disposed at at least one location of an open end of the input recessed portion and having a through-hole formed at a center; and
output fixing means disposed at at least one location of the cylinder, the output-side lid portion, and the input-side lid for fixing an output attachment that receives an expanded thrust output from the output rod,
wherein the output attachment is a replaceable working jig corresponding to a working step or a replaceable assembling jig corresponding to an assembling step, and
the connecting unit according to claim 20, which connects the plurality of thrust expansion devices to each other,
wherein the output fixing means for fixing the output attachment that receives an expanded thrust output from the output rod is individually provided in the plurality of thrust expansion devices, and
wherein each of the output attachments is a replaceable working jig corresponding to a working step or a replaceable assembling jig corresponding to an assembling step.

24. A connecting unit which is connected to two expansion input recessed portions opposite to each other of which inner circumferential surfaces on an open end side are the same so as to connect two expansion units according to claim 19,
the connecting unit comprising a through-hole through which both of the fluid chambers connected to each other communicate with each other.

25. A connecting unit which is connected to a thrust expansion device and an expansion unit, wherein the thrust expansion device that expands and outputs a thrust input from an input actuator by connecting the input actuator to an input side,
the device comprising:
a cylinder including an output surface portion having a predetermined output surface, an opposite surface portion disposed to be opposite to the output surface portion, and a plurality of side surface portions disposed on a side of the output surface portion;
an output recessed portion constituting a part of a fluid chamber and being formed on the output surface portion;
a fluid piston including a piston portion disposed in the output recessed portion and moving in a thrust direction in the cylinder, and an output rod connected to the piston portion and outputting the thrust;
an output-side lid portion connected to the output recessed portion and having a through-hole in which the output rod moves in the thrust direction;
an input recessed portion constituting a part of the fluid chamber, communicating with the fluid chamber of the output recessed portion, and being formed at at least two locations of the opposite surface portion and the plurality of side surface portions; and
an input-side lid disposed at at least one location of an open end of the input recessed portion and having a through-hole formed at a center,
wherein inner circumferential surfaces of the plurality of input recessed portions on an open end side are formed in the same shape at at least two locations, and
wherein the expansion unit that is connected to the input-side lid disposed at the open end of the thrust expansion device, and transmits a thrust from an input actuator,
the thrust expansion unit comprising:
an expansion cylinder which includes a bottom surface portion having a bottom portion, an expansion opposite surface portion disposed to be opposite to the bottom surface portion, and a plurality of expansion side surface portions disposed on a side of the bottom surface portion, and in which one location of the expansion opposite surface portion or the expansion side surface portion and the input-side lid are connected;
an expansion input recessed portion constituting a part of the fluid chamber, communicating with the fluid chamber of the thrust expansion device, and being formed at at least two locations of the expansion opposite surface portion and the plurality of expansion side surface portions;
an expansion input-side lid which is not connected to the input-side lid of the thrust expansion device, is disposed at at least one location of an open end of the expansion input recessed portion, and has a through-hole formed at a center; and
an expansion sealing lid which is disposed on an open end side where the expansion input-side lid is not disposed in the open end and seals an open surface,
wherein inner circumferential surfaces of the plurality of expansion input recessed portions on the open end side are formed in the same shape as the input recessed portion of the thrust expansion device, and
wherein the connecting unit which is connected to the input recessed portion and the expansion input recessed portion opposite to each other of which inner circumferential surfaces on an open end side are the same so as to connect the thrust expansion and the expansion unit to each other,
the connecting unit comprising a through-hole through which both of the fluid chambers connected to each other communicate with each other.

26. A thrust expansion system comprising at least one thrust expansion device that expands and outputs a thrust input from an input actuator by connecting the input actuator to an input side,
the device comprising:
a cylinder including an output surface portion having a predetermined output surface, an opposite surface portion disposed to be opposite to the output surface portion, and a plurality of side surface portions disposed on a side of the output surface portion;
an output recessed portion constituting a part of a fluid chamber and being formed on the output surface portion;
a fluid piston including a piston portion disposed in the output recessed portion and moving in a thrust direction in the cylinder, and an output rod connected to the piston portion and outputting the thrust;
an output-side lid portion connected to the output recessed portion and having a through-hole in which the output rod moves in the thrust direction;
an input recessed portion constituting a part of the fluid chamber, communicating with the fluid chamber of the output recessed portion, and being formed at at least two locations of the opposite surface portion and the plurality of side surface portions; and
an input-side lid disposed at at least one location of an open end of the input recessed portion and having a through-hole formed at a center,
wherein at least one expansion unit that is connected to the input-side lid disposed at the open end of the thrust expansion device, and transmits a thrust from an input actuator,
the thrust expansion unit comprising:
an expansion cylinder which includes a bottom surface portion having a bottom portion, an expansion opposite surface portion disposed to be opposite to the bottom surface portion, and a plurality of expansion side surface portions disposed on a side of the bottom surface portion, and in which one location of the expansion opposite surface portion or the expansion side surface portion and the input-side lid are connected;
an expansion input recessed portion constituting a part of the fluid chamber, communicating with the fluid chamber of the thrust expansion device, and being formed at at least two locations of the expansion opposite surface portion and the plurality of expansion side surface portions;
an expansion input-side lid which is not connected to the input-side lid of the thrust expansion device, is disposed at at least one location of an open end of the expansion input recessed portion, and has a through-hole formed at a center; and
an expansion sealing lid which is disposed on an open end side where the expansion input-side lid is not disposed in the open end and seals an open surface,
wherein inner circumferential surfaces of the plurality of expansion input recessed portions on the open end side are formed in the same shape as the input recessed portion of the thrust expansion device; and the connecting unit according to claim 24 which is disposed between two expansion units, which are opposite to each other, and connects both respectively.

27. A thrust expansion system comprising:
at least one thrust expansion device that expands and outputs a thrust input from an input actuator by connecting the input actuator to an input side,
the device comprising:
a cylinder including an output surface portion having a predetermined output surface, an opposite surface portion disposed to be opposite to the output surface portion, and a plurality of side surface portions disposed on a side of the output surface portion;
an output recessed portion constituting a part of a fluid chamber and being formed on the output surface portion;
a fluid piston including a piston portion disposed in the output recessed portion and moving in a thrust direction in the cylinder, and an output rod connected to the piston portion and outputting the thrust;
an output-side lid portion connected to the output recessed portion and having a through-hole in which the output rod moves in the thrust direction;
an input recessed portion constituting a part of the fluid chamber, communicating with the fluid chamber of the output recessed portion, and being formed at at least two locations of the opposite surface portion and the plurality of side surface portions; and
an input-side lid disposed at at least one location of an open end of the input recessed portion and having a through-hole formed at a center,
wherein at least one expansion unit that is connected to the input-side lid disposed at the open end of the thrust expansion device, and transmits a thrust from an input actuator,
the thrust expansion unit comprising:
an expansion cylinder which includes a bottom surface portion having a bottom portion, an expansion opposite surface portion disposed to be opposite to the bottom surface portion, and a plurality of expansion side surface portions disposed on a side of the bottom surface portion, and in which one location of the expansion opposite surface portion or the expansion side surface portion and the input-side lid are connected;
an expansion input recessed portion constituting a part of the fluid chamber, communicating with the fluid chamber of the thrust expansion device, and being formed at at least two locations of the expansion opposite surface portion and the plurality of expansion side surface portions;
an expansion input-side lid which is not connected to the input-side lid of the thrust expansion device, is disposed at at least one location of an open end of the expansion input recessed portion, and has a through-hole formed at a center; and
an expansion sealing lid which is disposed on an open end side where the expansion input-side lid is not disposed in the open end and seals an open surface,
wherein inner circumferential surfaces of the plurality of expansion input recessed portions on the open end side are formed in the same shape as the input recessed portion of the thrust expansion device; and the connecting unit according to claim 25 which is disposed between the thrust expansion device and the expansion unit, which are opposite to each other, and connects both respectively.
